(19) United States
(12) Patent Application Publication
(10) Pub. No.: US 2013/0100176 A1
(43) Pub. Date: Apr. 25, 2013

(54) SYSTEMS AND METHODS FOR OPTIMIZING FRAME RATE AND RESOLUTION FOR DISPLAYS

(71) Applicant: Qualcomm Mems Technologies, Inc., San Diego, CA (US)

(72) Inventors: Alan G. Lewis, Sunnyvale, CA (US); Karen T. Fisher, Berkeley, CA (US); William J. Cummings, Clinton, WA (US); Peter A. Thompson, Millbrae, CA (US)

(73) Assignee: QUALCOMM MEMS TECHNOLOGIES, INC., San Diego, CA (US)

(21) Appl. No.: 13/653,262

(22) Filed: Oct. 16, 2012

Related U.S. Application Data
(60) Provisional application No. 61/550,266, filed on Oct. 21, 2011.

(51) Int. Cl. G09G 5/02

(52) U.S. Cl. CPC G09G 5/02; G09G 2310/06
USPC 345/690

(57) ABSTRACT

This disclosure describes systems, methods, and apparatus for increasing the frame rate of a display, while maintaining or improving image resolution. In one aspect, displays may include a plurality of pixels arranged along segment lines and common lines, and the common lines may be associated with one or more colors. In one implementation, one set of common lines is written independently of the other common lines, and at least one other set of common lines is written simultaneously. The resolution is preserved by the independent writing of one set of common lines, while the frame rate is increased by the line multiplication of another set of common lines.

### CROSS-REFERENCE TO RELATED APPLICATIONS

The present application claims the benefit under 35 U.S.C. §119(e) of U.S. Provisional Patent Application No. 61/550,266, filed on Oct. 21, 2011, entitled “SYSTEMS AND METHODS FOR OPTIMIZING FRAME RATE AND RESOLUTION FOR DISPLAYS,” the entire contents of which is hereby incorporated by reference herein in its entirety and for all purposes.

### TECHNICAL FIELD

This disclosure relates to an update scheme for an electromechanical device-based display apparatus.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

In one implementation of this disclosure, a color display comprises a plurality of common lines, a plurality of segment lines, and a plurality of electromechanical display elements. In this implementation, each electromechanical display element is in electrical communication with one of said plurality of common lines and one of said plurality of segment lines. Substantially all of the electromechanical display elements along a first set of one or more common lines may include electromechanical display elements configured to display a first color, and substantially all of the electromechanical display elements along a second set of two or more common lines may include electromechanical display elements configured to display a second color. In this implementation, the color display includes driver circuitry configured to simultaneously apply a first plurality of data signals across a plurality of segment lines. The driver circuitry may also be configured to apply a first write waveform across only the first set of one or more common lines to selectively control the state of electromechanical display elements in electrical communication with the first set of one or more common lines, and to simultaneously apply a second plurality of data signals across a plurality of segment lines. Moreover, in this implementation, the driver circuitry is configured to simultaneously apply second write waveforms across the second set of two or more common lines to selectively control the state of electromechanical display elements in electrical communication with the second set of two or more common lines. The second set of two or more common lines may include more common lines than the first set of one or more common lines.

Another innovative aspect of the subject matter described in this disclosure can be implemented in a method of driving a color display, the color display comprising a plurality of electromechanical display elements. In this implementation, each electromechanical display element is in electrical communication with one of a plurality of segment lines and one of a plurality of common lines. The method comprises simultaneously applying a first plurality of data signals across a plurality of segment lines, and applying a first write waveform across only a first set of one or more common lines to selectively control the state of electromechanical display elements in electrical communication with the first set of one or more common lines. In this implementation, substantially all of the electromechanical display elements along the first set of one or more common lines include electromechanical display elements configured to display a first color. The method further comprises simultaneously applying a second plurality of data signals across a plurality of segment lines, and simultaneously applying second write waveforms across at least a second set of two or more common lines to selectively control the state of electromechanical display elements in electrical communication with the second set of two or more common lines. In one implementation, substantially all of the electromechanical display elements along the second set of two or more common lines include electromechanical display elements configured to display a second color. The second set of two or more common lines may include more common lines than the first set of one or more common lines.

Yet another implementation includes a computer-readable storage medium comprising instructions which, when executed by one or more processors, cause a computer to perform a method of driving a color display. In this implementation, the color display comprises a plurality of electromechanical display elements, and each electromechanical display element is in electrical communication with one of a plurality of segment lines and one of a plurality of common lines. The instructions cause a computer to perform a method comprising simultaneously applying a first plurality of data signals across a plurality of segment lines, and applying a first write waveform across only a first set of one or more common lines to selectively control the state of electromechanical display elements in electrical communication with the first set of one or more common lines. In one implementation, substantially all of the electromechanical display elements along said first set of one or more common lines include electromechanical display elements configured to display a first color. The instructions further cause a computer to perform a method comprising simultaneously applying a second plurality of data signals across a plurality of segment lines, and simultaneously applying second write waveforms across at least a second set of two or more common lines to selectively control the state of electromechanical display elements in electrical communication with the second set of two or more common lines. In one implementation, substantially all of the electromechanical display elements along the second set of two or more common lines include electromechanical display elements configured to display a second color. The second set of two or more common lines may include more common lines than the first set of one or more common lines.

Yet another inventive aspect of the present disclosure can be implemented in a display comprising a plurality of electromechanical display elements, with each electromechanical display element in electrical communication with one of a plurality of segment lines and one of a plurality of common lines. The display further includes means for simultaneously applying a first plurality of data signals across a plurality of segment lines, and means for applying a first write waveform across a first set of one or more common lines to selectively control the state of electromechanical display elements in electrical communication with the first set of one or more common lines. In one implementation, substantially all of the electromechanical display elements along the first set of one or more common lines include electromechanical display elements configured to display a first color. The display further comprises means for simultaneously applying a second plurality of data signals across a plurality of segment lines, and means for simultaneously applying second write waveforms across at least a second set of two or more common lines to selectively control the state of electromechanical display elements in electrical communication with the second set of two or more common lines. In an implementation, substantially all of the electromechanical display elements along the second set of two or more common line include electromechanical display elements configured to display a second color. The second set of two or more common lines may include more common lines than the first set of one or more common lines.

Another implementation may be implemented in a method of writing a frame that is performed in a display having a set of red common lines, a set of green common lines, and a set of blue common lines. In this implementation, the method for writing a frame comprises writing image data using more write cycles for green common lines than for at least one of red and blue common lines.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 shows an example of an array of electromechanical display elements including a plurality of common lines and a plurality of segment lines.

FIG. 10 shows an example of a flow diagram illustrating a process for writing a portion of a frame using a line multiplying process.

FIG. 11 shows an example of a flow diagram illustrating a process for writing monochrome image data to at least a portion of a color display.

FIG. 12 shows an example of a flow diagram illustrating a process for writing data to at least a portion of a display.

FIG. 13 shows an example of a flow diagram illustrating a process for writing data to a display using with a reduced frame rate in at least one frame.

FIG. 14 shows an example of a flow diagram illustrating a process for writing data to a display using a selective common line multiplication process.

FIG. 15 shows an example diagram illustrating a display device that writes image data to multiple frames using a complete common line multiplication process.

FIG. 16 shows an example diagram illustrating a display device that writes image data to multiple frames using a selective common line multiplication process.

FIG. 17 shows an example of an array of electromechanical display elements including a plurality of common lines and a plurality of segment lines, and includes an example common line writing scheme for a single frame.

FIG. 18 shows an example diagram illustrating a display device that writes image data to multiple frames using a selective common line multiplication process that leaves some common lines unwritten during a particular frame.

FIG. 19 shows an example of an array of electromechanical display elements including a plurality of common lines and a plurality of segment lines, and includes an example common line writing scheme for multiple frames.

FIG. 20 shows an example of a flow diagram illustrating a process for writing data to a display using a selective common line multiplication process for two sets of common lines, according to another implementation.

FIG. 21 shows an example of an array of electromechanical display elements including a plurality of common lines and a plurality of segment lines, and includes an example common line writing scheme for a single frame, according to one implementation.

FIG. 22 shows an example of an array electromechanical display elements including a plurality of common lines and a plurality of segment lines, and includes an example common line writing scheme for a single frame, according to another implementation.

FIG. 23 shows an example of an array of electromechanical display elements including a plurality of common lines and a plurality of segment lines, and includes an example common line writing scheme for a single frame, according to another implementation.

FIG. 24 shows an example of an array of electromechanical display elements including a plurality of common lines and a plurality of segment lines, and includes an example common line writing scheme for a single frame, according to yet another implementation.

FIGS. 25A and 25B show examples of system block diagrams illustrating a display device that includes a plurality of interferometric modulators.

Like reference numbers and designations in the various drawings indicate like elements, unless otherwise indicated.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

For many displays, including displays which rely on the actuation of electromechanical elements to alter the information displayed therein, the time spent writing data to a particular section of the display may be a limiting factor in the refresh rate or frame rate of the display. If multiple sections of the display can be addressed simultaneously, the refresh rate or line rate can be improved. In certain implementations, identical data can be simultaneously written to display elements which are close to one another or even adjacent to one another, effectively reducing the resolution of the display and increasing the refresh rate or frame rate of a display. In another implementation, the same information can be used to control the state of multiple colors of subpixels within a color display, increasing the refresh rate or frame rate of the display by reducing the color range of the pixels, rather than reducing the resolution of the display.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

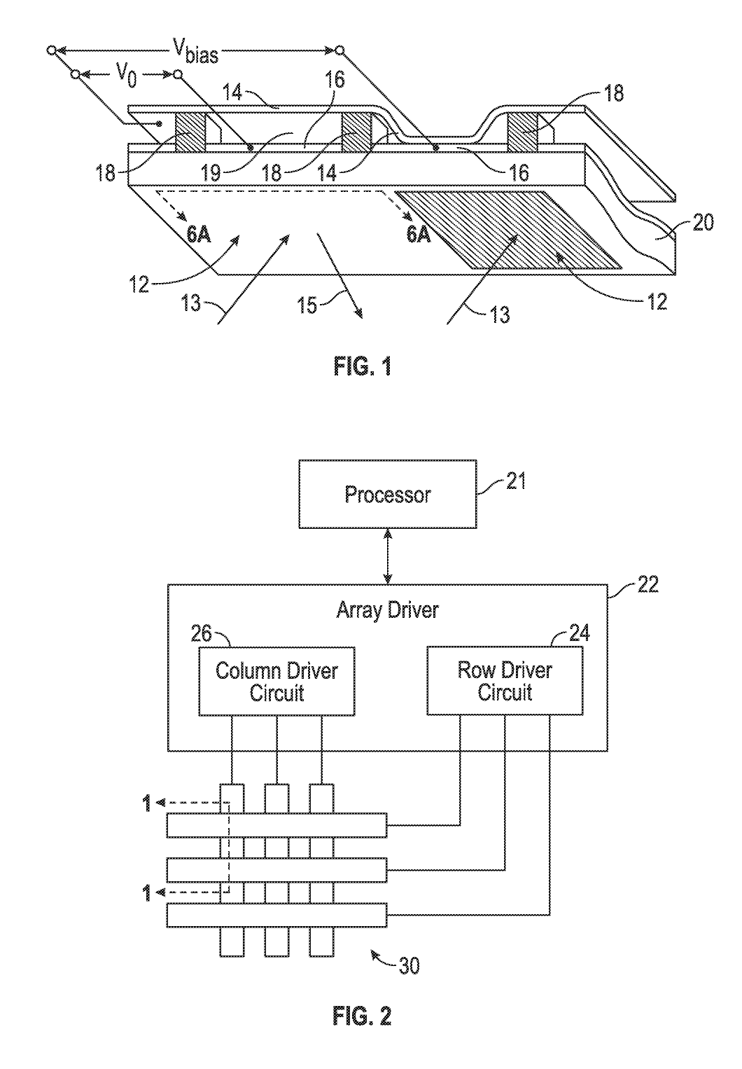

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

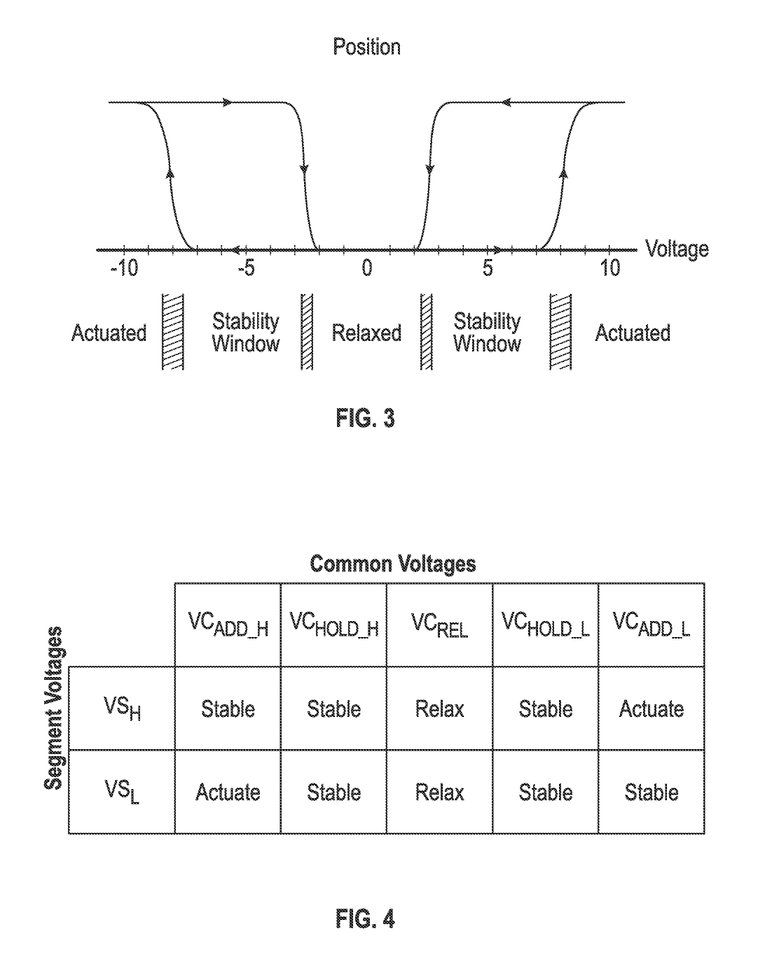

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

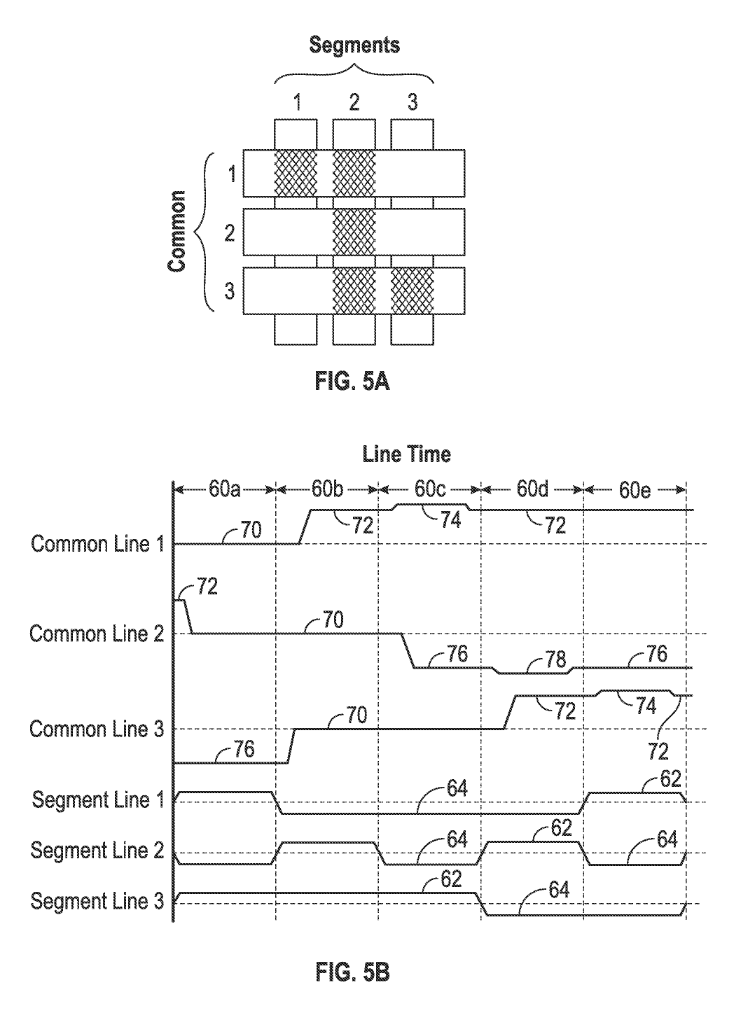

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}-relax and VC_{HOLD L}-stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

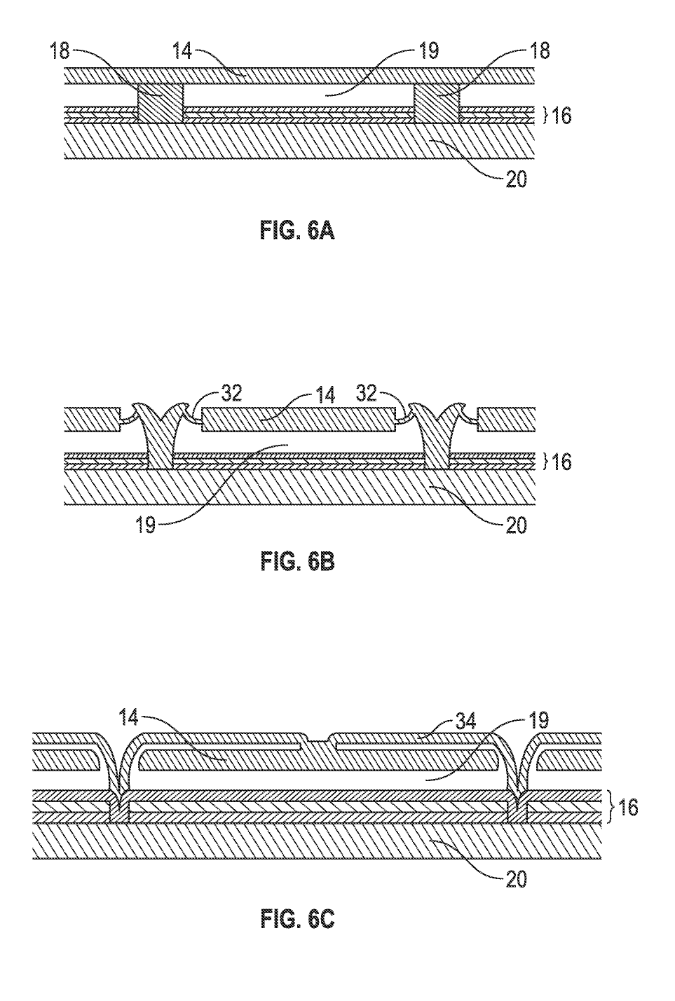

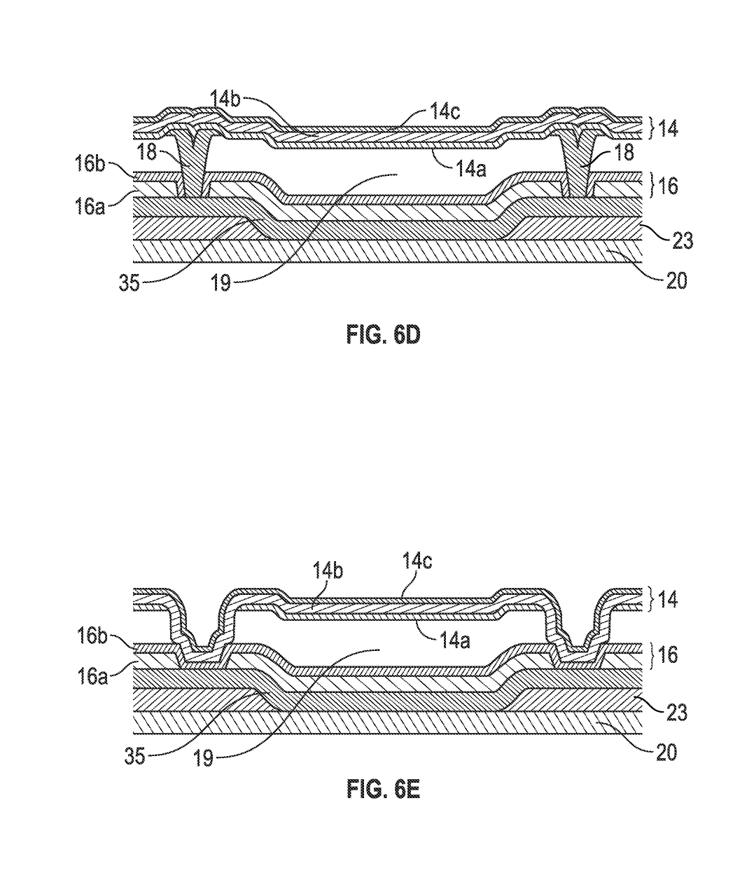

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

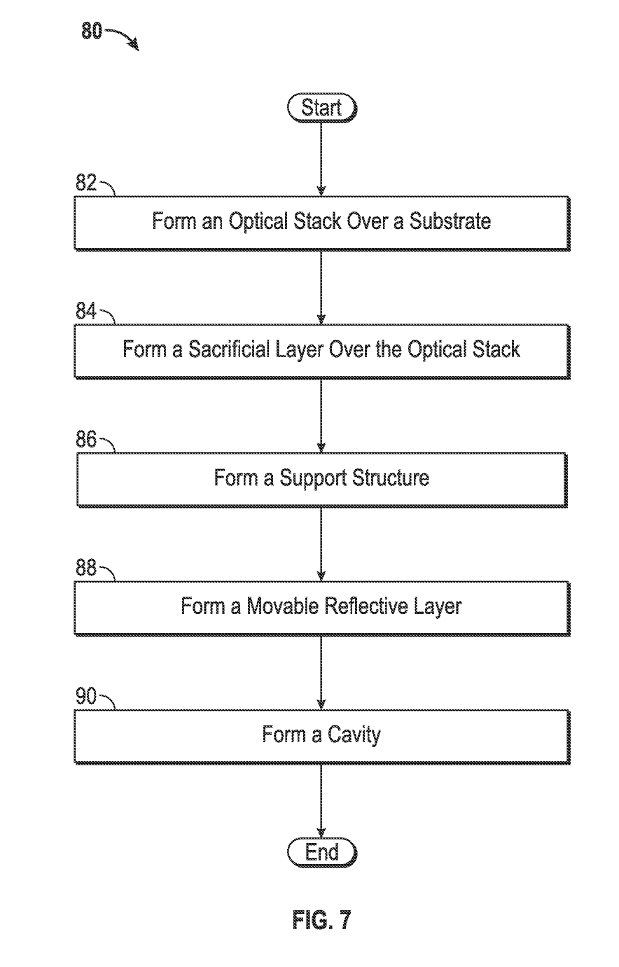

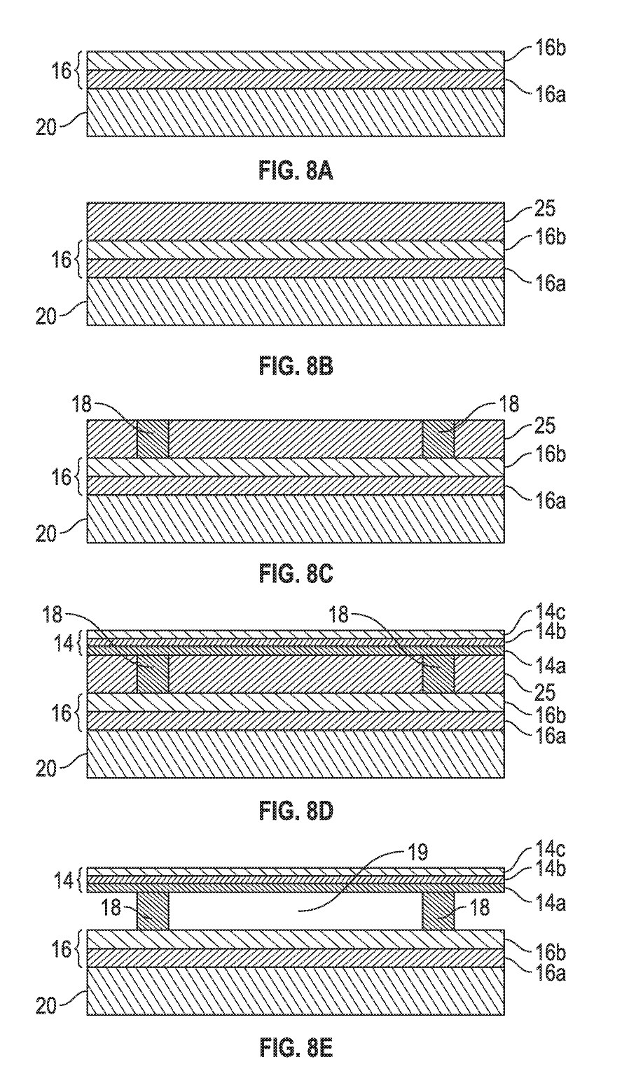

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In certain displays, the time used to write data to particular display elements will place constraints on the overall rate at which the display can be refreshed. If each common line is separately addressed, the write time for each line will determine the overall frame write time. In certain implementations, an increased refresh rate or frame rate of the display may be desired, and may be more important than the resolution or color range of the display. In particular implementations, driver circuitry and display arras which are capable of presenting high resolution images with a wide color range may be utilized in a manner which reduces either or both of the resolution and the color range in order to increase the potential refresh rate of the display.

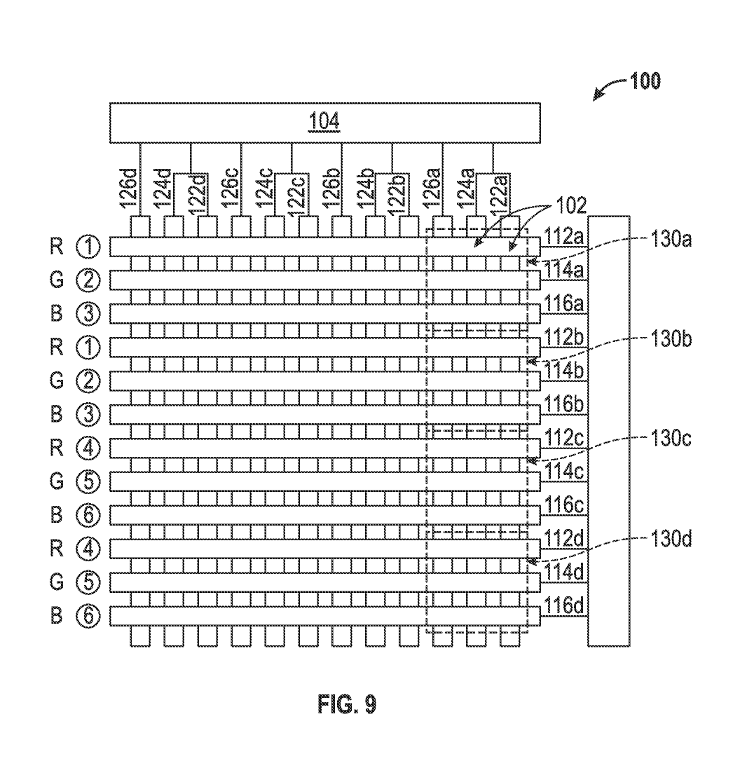

FIG. 9 shows an example of an array 100 of electromechanical display elements 102 including a plurality of common lines and a plurality of segment lines. In certain implementations, the electromechanical display elements 102 may include interferometric modulators. A plurality of segment electrodes or segment lines 122a-122d, 124a-124d, and 126a-126d and a plurality of common electrodes or common lines 112a-112d, 114a-114d, and 116a-116d can be used to address the display elements 102, as each display element will be in electrical communication with a segment electrode and a common electrode. Segment driver circuitry 104 is configured to apply desired voltage waveforms across each of the segment electrodes, and common driver circuitry is configured to apply desired voltage waveforms across each of the column electrodes. In certain implementations, some of the electrodes may be in electrical communication with one another, such as segment electrodes 122a and 124a, such that the same voltage waveform can be simultaneously applied across each of the segment electrodes.

Still with reference to FIG. 9, in an implementation in which the array 100 includes a color display or a monochrome grayscale display, the individual electromechanical elements 102 may form subpixels of larger pixels, where the pixels include some number of subpixels, In an implementation in which the array includes a color display including a plurality of interferometric modulators, the various colors may be aligned along common lines, such that substantially all of the display elements along a give common line include display elements configured to display the same color. Certain implementations of color displays include alternating lines of red, green, and blue subpixels. For example, common lines 112a-112d may correspond to lines of red interferometric modulators, common lines 114a-114d may correspond to lines of green interferometric modulators, and common lines 116a-116d may correspond to lines of blue interferometric modulators. In a particular implementation, each 3×3 array of interferometric modulators 102 forms a pixel such as pixels 130a-130d. In the illustrated implementation in which two of the segment electrodes are shorted to one another, such a 3×3 pixel will be capable of rendering 64 different colors. In other implementations, larger groups of interferometric modulators may be used to form pixels having a greater color range at the cost of overall pixel count or resolution.

Sometimes, such as in the display of video or other animation, high refresh rate or frame rate may be more important to good visual appearance than the resolution of the display. For example, a low-resolution preview image may be shown and then replaced with a full-resolution image, or a GUI including a zooming animation may display the zooming animation at a lower resolution and then return to a higher resolution when the zooming animation is complete. In some implementations, resolution is sacrificed for higher frame rate by simultaneously applying identical voltage waveforms across multiple common lines. For the display elements in electrical communication with a given segment line and one of the common lines across which the identical voltage waveforms are simultaneously applied, identical data will be written to those display elements.

In further implementations, when the resolution of the display is greater than the resolution of the source data, simultaneously writing identical data to multiple display elements can reduce the frame write time without having any negative visual effect on the resulting image, as identical data would already have been written to certain adjacent display elements. Video data, for example, is frequently viewed on displays which have a higher resolution than the video data itself, although many other types of image source data may be lower resolution than the display to which the image data will be written. The use of line multiplication to write the same data to multiple lines advantageously decreases the frame write time, increasing the possible refresh rate without a detrimental impact on the final display image.

Although the term “simultaneously” is used throughout this discussion for the purposes of conciseness, the voltage waveforms need not be perfectly synchronized. As discussed above with respect to FIG. 5B, the write waveform may include an overdrive or address voltage during which the potential difference across a display element is sufficient to result in data being written to that display element given an appropriate segment voltage. So long as there is sufficient overlap between the overdrive or address voltages of the write waveforms applied across the common lines and the data signals applied across the segment lines that actuation of the display elements on any of the addressed common lines can occur, the write waveforms and data signals are considered to be applied simultaneously.

In particular implementations, the resolution can be effectively reduced by simultaneously applying the same waveforms across common lines corresponding to display elements of the same color. For example, if a write waveform is simultaneously applied across red common lines 112a and 112b to address those common lines, the data pattern written to the interferometric modulators along common line 112a will be identical to the data pattern written to the interferometric modulators along common line 112b. If write waveforms are simultaneously applied across green common lines 114a and 114b, and then across blue common lines 116a and 116b, the data pattern written to pixel 130a will be identical to the data pattern written to pixel 130b, causing pixel 130a to display the same color as pixel 130b.

In comparison to a write process in which each common line is individually addressed, data has been written to pixels 130a and 130b in as little as half the time it would have taken to write separate data to pixels 130a and 130b, at the cost of decreased vertical resolution. If this line multiplying process is applied to the remainder of the common lines in the display, the frame write time is considerably reduced.

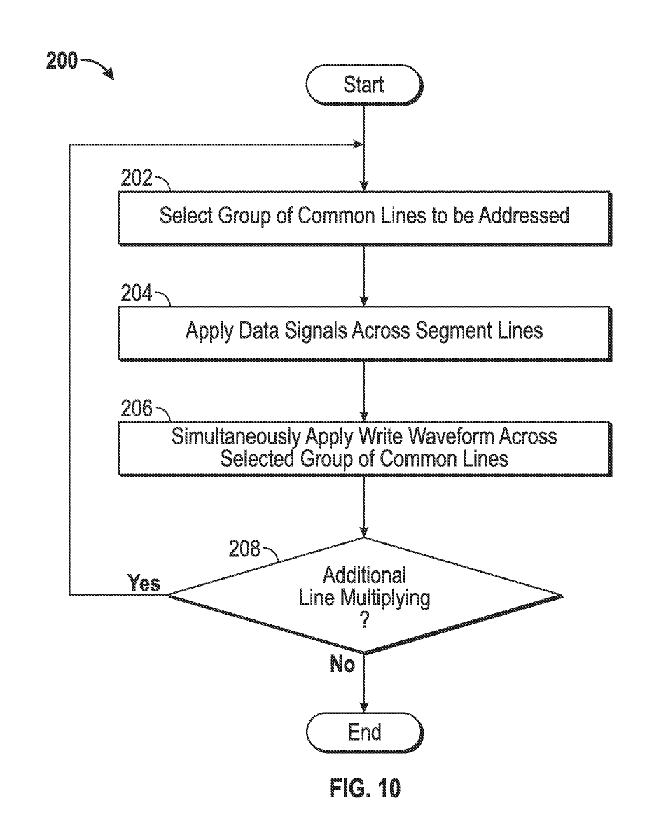

FIG. 10 shows an example of a flow diagram illustrating a process for writing a portion of a frame using a line multiplying process. The frame write process 200 reduces the overall frame write time through the use of line multiplication. This particular frame write process may represent only a portion of the complete frame write, and may occur at the beginning, middle, or end of the complete frame write. Thus, image data may already have been written to one or more common lines within the frame. At block 202, a pair or group of common lines to be simultaneously addressed is identified.

At block 204, a plurality of data signals are applied along segment lines. Simultaneously, at block 206 a first write waveform is simultaneously applied to at least two common lines in the array to address the waveforms. Such a write waveform may include, for example, a positive or negative overdrive or address voltage appropriate for the common lines being addressed, as described with respect to FIG. 5B above. Hold voltages may be simultaneously applied to multiple common lines not being addressed, and reset voltages may be applied to common lines prior to addressing the common lines. When the write waveform is applied along a pair or group of column lines to be addressed, the application of properly selected data signals along the segment lines will not result in an accidental actuation or accidental release of display elements along common lines not being addressed.

For example, in implementations where the display elements are bistable electromechanical devices exhibiting hysteresis, such as interferometric modulators, segment voltages can be used which have a variance between their maximum and minimum values which is less than the width of the hysteresis windows of the electromechanical devices. For appropriate hold voltages, the potential difference across the electromechanical devices will remain within the hysteresis window of the devices whether the segment voltage is at its maximum or minimum value. Similarly, when reset voltages are applied across common lines not being addressed, properly selected reset and segment voltages will ensure release of the electromechanical devices regardless of the state of the data signal applied across a given segment line.

Although the flowchart of FIG. 10 illustrates block 204 as taking place before block 206, the desired actuation will occur so long as there is sufficient overlap between the write waveform and the plurality of data signals to allow all the electromechanical devices sufficient time to actuate or release in accordance with the applied data signals. The frame write time can thus be reduced by maximizing the overlap between the write waveform of block 206 and the data signals of block 204, and blocks 204 and 206 can occur in either order so long as there is overlap between the application of the signals.

At block 208, a determination is made as to whether any additional pairs or groups of common lines are to be simultaneously addressed. If so, the process returns to block 202 to select an appropriate pair or group of common lines to simultaneously address. If not, the process moves to further steps which could include a termination of the frame write process if there are additional common lines to be addressed, or could include individual addressing of certain common lines. In addition, simultaneous addressing of pairs or groups of common lines may be interspersed with individual addressing of common lines, depending on the nature of the data to be written. For example, if a portion of the image data written to a display includes text or another still image, and another portion of the data includes a video which can be displayed at a lower resolution and which is located vertically between sections of text or still image, the portions of the display located above the video can be written by individually addressing those common lines, the portions of the display including the video can be written at a lower resolution by utilizing a line multiplying write process, and the write process may return to individual addressing of the common lines of the display for the portion of the display located below the video.

The array 100 in FIG. 9 may be written according to the line multiplication process of FIG. 10. One such implementation is shown in FIG. 9 by reference to the ordering numerals to the left of the array. The ordering numerals illustrate one temporal order in which the common lines 112a-112d, 114a-114d, and 116a-116d may be written during a line multiplication process. For example, step (1) is a line writing process that writes two red common lines 112a and 112b. Step (2) is a line writing process that simultaneously writes green common lines 114a and 114b. Step (3) is a line writing process that writes two blue common lines 116a and 116b. These three steps write identical data to the first two pixel rows. Step (4) is a line writing process that simultaneously writes red common lines 112c and 112d. Step (5) is a line writing process that writes two green common lines 114c and 114d, and step (6) is a line writing process that simultaneously writes blue common lines 116c and 116d.

The particular method of line multiplication discussed above with respect to FIG. 9 advantageously applies identical write waveforms to common lines in adjacent pixels, although other pairs of common lines may be simultaneously addressed in other implementations. Furthermore, even if the line multiplying method is used to simultaneously apply write waveforms to common lines in adjacent pixels, all of the lines in a given pair or group of pixels need not be written before writing lines in other groups of pixels. In particular, in certain implementations it may be advantageous to address multiple pairs or groups of common lines of the same color before addressing common lines of another color. For example, red common lines 112a and 112b may be simultaneously addressed, followed by a subsequent write process which simultaneously addresses red common lines 112c and 112d. Because different voltage waveforms may be used to address common lines of different color display elements, it may be advantageous to utilize the write waveform appropriate for a particular color for multiple pairs or groups of common lines before addressing common lines of another color. In particular implementations, any number of pairs or groups of common lines of a given color may be sequentially addressed before addressing common lines of another color. For example, in certain implementations 5 pairs or groups of common lines of a given color may be addressed before common lines of another color are addressed, although larger or smaller numbers of pairs or groups may be used, as well.

In addition, although the simultaneous application of substantially identical waveforms to two common lines is discussed herein, further increases in refresh rate or frame write or reductions in power usage may be achieved by simultaneously applying substantially identical waveforms to more than two common lines, or by applying identical data signals across two or more segment lines.

In some methods of updating data on a display, charge buildup on particular display elements may be reduced by altering the polarity of the write waveforms applied to the common line. In one implementation, which may be referred to as frame inversion, a given frame is fully addressed using write waveforms of a particular polarity, and a subsequent frame is fully addressed using write waveforms of the opposite polarity. In further implementations, however, the polarity of write waveforms may be altered during a single frame write. In a particular implementation, which may be referred to as line inversion, the polarity of the write may be altered after addressing each line, and the polarity used to address a particular line will be changed in subsequent frames. If the display is being updated in a substantially linear fashion, this may result in adjacent lines being addressed by write voltages having opposite polarities. Thus, in certain implementations, it may be advantageous to utilize a given write waveform having a given polarity to write to, for example, every other red common line with a positive polarity for some number of common lines, before writing to the skipped red common lines with a negative polarity.

Polarity inversion within a frame can be applied to a write process in which line multiplying is used as well. In one implementation, red lines 112c and 112d may be addressed using the opposite polarity of that used to address red lines 112a and 112b within a given frame write. In an implementation such as the one described above where a write waveform with a given polarity is used for multiple sequential addressing operations, red lines 112a and 112b may be addressed using a first polarity, and red lines 112c and 112d may be skipped while some number of additional pairs or groups of red lines are written using the first polarity. After some number of pairs or groups have been addressed using the first polarity, red lines 112c and 112d may be addressed using the opposite polarity.

If polarity inversion is utilized, addressing a certain number of lines of one color using a first polarity need not be followed by addressing a certain number of lines in the same color using the opposite polarity. In other implementations, positive red write processes may be followed by, for example, negative blue write processes, or positive green write processes.

In another implementation, a color display may be driven in a monochrome mode or other mode which reduces the available color range. The process of updating a display in this manner can reduce the refresh time of the display without decreasing the resolution of the display. In one implementation, the display can be driven in a monochrome manner by simultaneously applying write waveforms to adjacent common lines. For example, in an RGB display such as the one depicted in FIG. 9, the three adjacent common lines 112a, 114a, and 116a which extend through pixel 130a will be simultaneously addressed by applying a write waveform across each of these three common lines. In certain implementations, a write voltage specific to the color of the common line being addressed may be used on each of these three common lines, and in other implementations, a single write waveform selected to be suitable to address each of the various colors of display elements within the common lines may be used. If appropriate write waveforms are chosen, identical subpixels will be actuated on each of the common lines, and the pixel 130a can be driven as a grayscale pixel having four potential shades.

In other implementations, the range of possible colors can be reduced to increase the potential refresh rate without reducing the display to a monochrome display. For example, in a display having display elements of three distinct colors, two of the colors in a given pixel may be simultaneously addressed while the other color is independently addressed, yielding a color range which is more robust than monochrome but less robust than that possible if all three colors were independently addressed. In alternate implementations, one or more color could be left unaddressed.

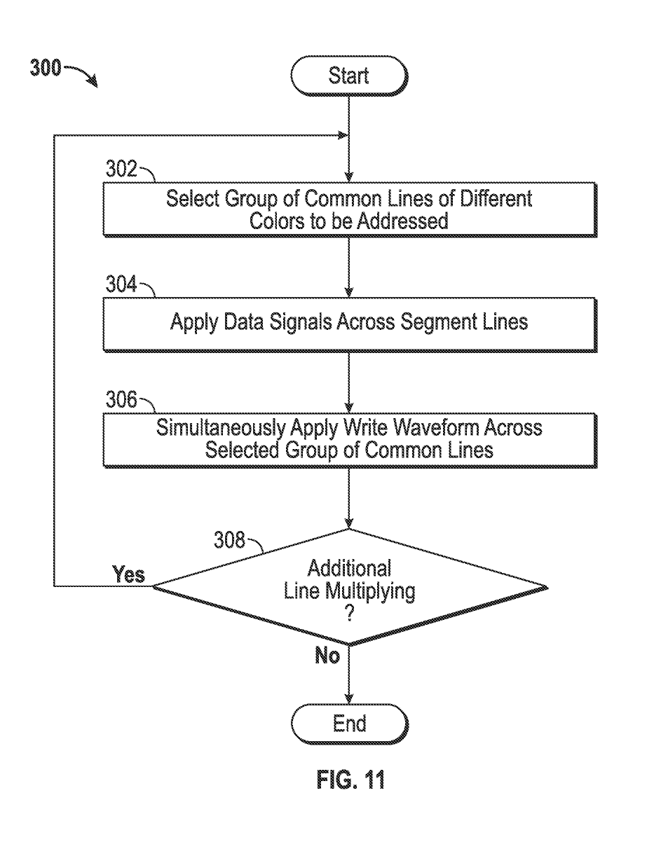

FIG. 11 shows an example of a flow diagram illustrating a process for writing monochrome image data to at least a portion of a color display. This frame write process 300 reduces the overall frame write time of a display through the use of a monochrome mode for at least a portion of the display. As discussed above with respect to the frame write process 200, this process may be used for the entire frame rate, or only during portions at the beginning, middle, or end of the frame write Thus, image data from a given can be written to lines before and/or after the blocks illustrated in process 300.

At block 302, a group of common lines to be addressed is selected. In a display having three different colors of display elements, such as an RGB display, the group of selected colors may include the adjacent common lines of each color extending through a given pixel. At block 304, data signals are simultaneously applied across a plurality of segment lines. At block 306, write waveforms are simultaneously applied across each of the selected common lines. As discussed above, because this process includes simultaneous addressing of display elements of different colors, different write waveforms specific to the color of the common lines may be used for each of the colors being addressed, although a single write waveform appropriate for all colors being addressed may also be used in alternate implementations. Given sufficient overlap between blocks 304 and 306, the data signals result in the writing of image data to the addressed common lines.

At block 308, a determination is made as to whether or not the next line write will be a monochrome line write which will simultaneously address multiple common lines. If yes, the process returns to block 302 to select the common lines to be simultaneously addressed. If not, the process may move on to other steps, including color line writes which address only a single common line, or the frame write may be complete.

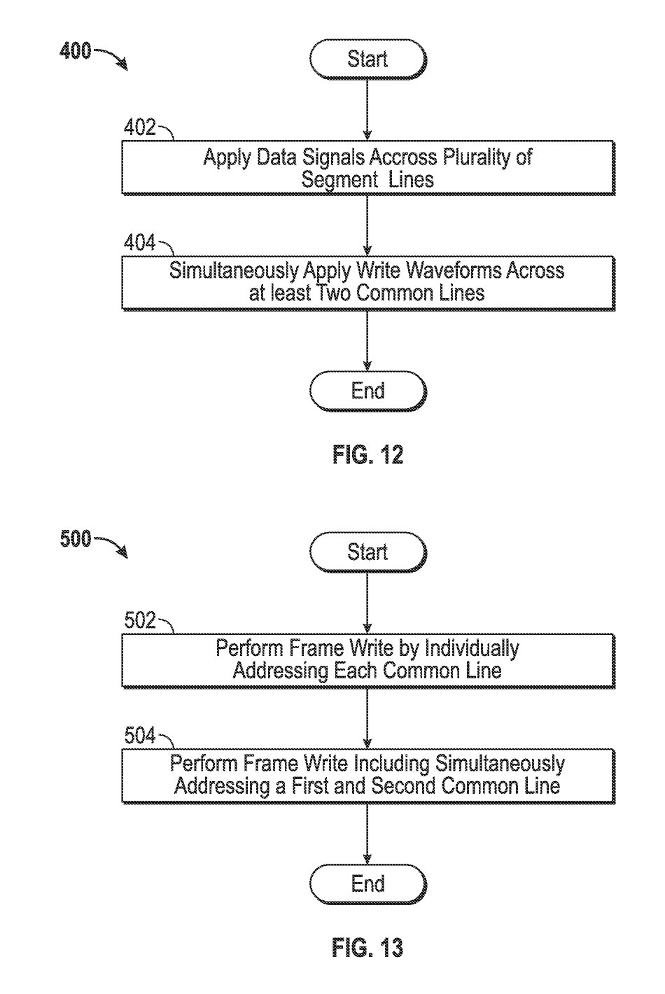

FIG. 12 shows an example of a flow diagram illustrating a process for writing data to at least a portion of a display. This frame write process 400 may be used as part of a drive scheme for a color display including a plurality of electromechanical display elements, with each electromechanical display element in electrical communication with one of a plurality of segment lines and one of a plurality of common lines. This frame write process 400 begins at a block 402 where a plurality of data signals are simultaneously applied across a plurality of segment lines. The frame write process 400 then moves to a block 404, where write waveforms are simultaneously applied to first and second common lines of electromechanical display elements to selectively control the state of electromechanical display elements in electrical communication with the first and second column lines.

In one implementation of frame write process 400, substantially all of the electromechanical display elements along the first line are configured to display a first color, and substantially all of the electromechanical display elements along the first line are configured to display a second color. The first color may be the same color as the second color, or the first and second colors may be different.

This frame write process 400 can be used in conjunction with other write processes. For example, the frame write process 400 can be used to simultaneously address multiple common lines during part of an overall frame write, while other common lines in the display are individually addressed. In other implementations, the first and second common lines may be individually addressed during a first frame write, and simultaneously addressed using the frame write process 400 during a subsequent frame write.

FIG. 13 shows an example of a flow diagram illustrating a process for writing data to a display using a reduced frame rate in at least one frame. This frame write process 500 may be used as part of a drive scheme for a display including a plurality of individually addressable common lines, a plurality of segment lines, and a plurality of display elements, wherein each of said plurality of display elements is addressable via one of said plurality of common lines and one of said plurality of segment lines. The frame write process 500 begins at a block 502 where a frame write is performed in which each of the common lines in the display are individually addressed via a plurality of write waveforms. The frame write process 500 then moves to a block 504 where a separate frame write is performed in which at least a first and second common line are simultaneously addressed, so as to write the same data to the display elements along the first and second common lines, reducing the time for the overall frame write. This may be done, for example, by applying a single waveform or two similar waveforms to the first and second common lines. Thus, the frame write process 500 may be implemented through the use of driver circuitry which is configured to perform frame writes both by individually addressing each common line via a plurality of waveforms, or by simultaneously addressing at least two of the common lines in the display by applying either a single waveform to two or more common lines or by applying two substantially similar waveforms to two or more common lines.

In further implementations, line multiplying of the type discussed above may be used in only certain sections of a display, depending on the particular information to be displayed. Many implementations of display devices frequently display information such that large portions of the data are identical on different common lines. For example, space between lines of text on an eBook or other text display device may be solid white, or another color. In such an implementation, where the data to be written to pixels along multiple common lines remains constant for multiple common lines, the column lines sharing identical segment data may be written to or addressed simultaneously. When a write waveform is simultaneously applied to each of these common lines, the data on the segment lines will be written to each of the common lines being addressed. In addition to reducing the overall time for completing a frame write, additional power can be saved by minimizing segment voltage switches.

In some situations, a different tradeoff between frame rate and resolution may be desired. In one implementation, the frame rate or refresh rate may be improved, while gaining an increase in resolution over the implementations of, for example, FIGS. 9-10. The frame write time is determined by the number of common lines that are addressed during a particular frame. For example, in “full resolution” scans, each common line is addressed, and a write waveform is applied to every common line. (Note that, throughout this text, the term “writing” a common line will refer to the process of applying a write waveform to a common line.) The frame write time is directly proportional to the total number of common lines addressed during a frame write. As the number of common lines increases, the frame write time correspondingly increases. For FIG. 9, if there are N red common lines, N green common lines, and N blue common lines, then the frame write time is proportional to 3N for a “full resolution” scan (or frame rate is proportional to 1/3N), where each common line is addressed independently. Certain displays may, for example, have full resolution frame rates of approximately 15 Hz.

The implementations shown in FIGS. 9-10 illustrate implementations of a complete line multiplication process that reduces frame write time (and increases frame rate). In complete line multiplication, a write waveform may be applied simultaneously to a group of selected common lines. For example, as mentioned above, a write waveform may be applied simultaneously to two red common lines 112a and 112b. After writing the red common lines, two green common lines 114a and 114b may be written simultaneously, then two blue common lines 116a and 116b may be written simultaneously. In this particular example, the frame rate was increased by a factor of two (or, alternatively, the frame write time was reduced by a factor of two) because the line multiplication process only had to provide a write waveform for half the total number of common lines, or 1.5N total.

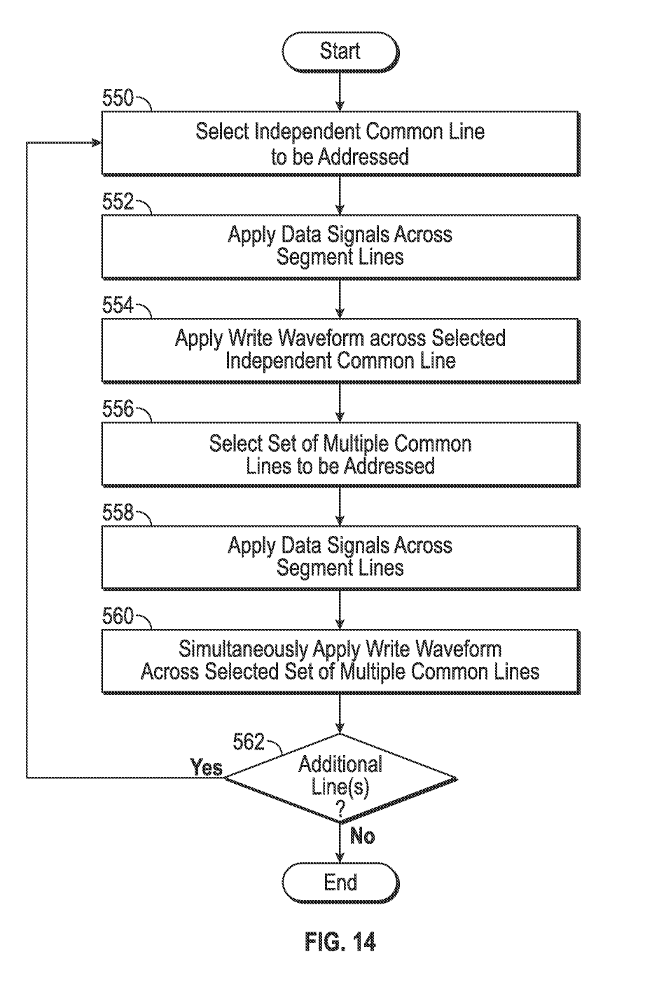

In a selective line multiplication process, on the other hand, some common lines may be written simultaneously in a line multiplication process, while other common lines may be written independently in an independent line process. In a selective line multiplication process, image data for some common lines are written in separate write cycles, and image data for other common lines are written in combined simultaneous write cycles. FIG. 14 shows an example of a flow diagram illustrating a method for writing a portion of a frame using a selective line multiplying process, which may comprise an independent line write process and a line multiplied write process. Blocks 550-554 illustrate an independent line process, whereby a single common line is addressed and written in a write cycle separately from other write cycles. In Block 550, one independent common line is selected to be addressed by the write waveform. Data signals are applied across the segment lines in Block 552, and a write waveform is applied across the selected independent common line in Block 554. The selected independent common line is thus written separately from the other common lines used in the frame.

Blocks 556-560 illustrate a line multiplication process 557, whereby multiple common lines may be written simultaneously in a combined simultaneous write cycle. In Block 556, a set of multiple common lines is selected. The set may include two or more common lines. Data signals are applied across the segment lines in Block 558, and a write waveform is simultaneously applied across the selected set of multiple common lines in Block 560. Thus, the selected group of multiple common lines is written simultaneously in a combined write cycle. In Block 562, if additional independent common lines are to be addressed, then the process loops back to Block 550, and the process in FIG. 14 may continue until all desired common lines are addressed. As illustrated in the example of FIG. 14, selected independent common lines are addressed separately from all other common lines written during a frame, and other multiple selected common lines are addressed simultaneously through line multiplication. Further, although the frame writing process illustrated in FIG. 14 and described above shows various example orders of writing particular common lines, it should be appreciated that the disclosed write orders are illustrative only. Indeed, the frame writing process may write independent common lines or multiple common lines in any desired order.

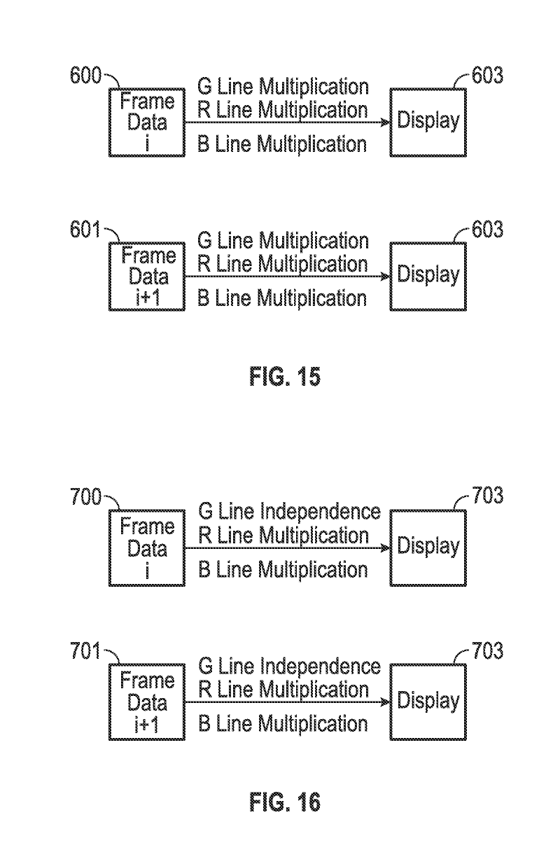

The methods illustrated by FIG. 14 may include common lines of different colors or of only one color. In some implementations as described above, different common lines may be formed by display elements of different colors, such as in red, green, and blue (RGB) display panels. The colors may be displayed in some implementations through activation of IMOD display devices, as described above. FIGS. 15 and 16 illustrate a few differences between the implementations of FIGS. 9-10 and the implementations of FIG. 14. In FIG. 15, an illustration of complete line multiplication frame writing is shown. The data for two consecutive frames 600 and 601 for display are shown as Data i and Data i+1, respectively, in FIG. 15. Each frame 600, 601 includes image data that defines a desired visual appearance for the frame. In the complete line multiplication frame writing process of FIG. 15, the image data set i is received by the display driver, and the display driver employs line multiplication to each of the green, red, and blue common lines, as shown in the line multiplication process 200 depicted in FIG. 10. In some implementations, the display driver applies a write waveform simultaneously across multiple green common lines in a combined write cycle, then applies a write waveform simultaneously across multiple red common lines, and finally applies a write waveform simultaneously across multiple blue common lines. In some implementations, the driver may simultaneously apply write waveforms to two common lines of each color in a combined write cycle, while other implementations may contemplate line multiplication of more than two common lines of each color. Moreover, different colors may be multiplied in different manners, such that more common lines associated with one color may be written simultaneously than common lines associated with another color. The line multiplication process may continue until all the desired common lines are addressed. The order illustrated in FIG. 15 and described above is also not required, as the frame writing process may write the colors in any desired order.

Upon writing the common lines, the image for frame 600 is displayed on display 603. After Data set i in frame 600 is written by the driver and displayed on display 603, the display driver processes Data set i+1 for use in the subsequent frame 601. In frame 601, the frame writing process may multiply lines in the same pattern as for frame 600 until frame 601 is written and displayed on display 603. As in frame 600, the common lines associated with each color are multiplied in frame 601, wherein a write waveform is applied simultaneously across multiple selected common lines of each color. Thus, in both frames 600 and 601, the selected green, red, and blue common lines are all multiplied.

FIG. 16, on the other hand, shows an example implementation of the selective line multiplication process described in FIG. 14. As in FIG. 15, FIG. 16 illustrates incoming image data for frames 700 and 701 as Data i and Data i+1, respectively. The data received in frames 700 and 701 may contain all the image information used in frames 600 and 601 of FIG. 15. However, as shown by the arrows, the green common lines may be written independently in both frames 700 and 701 in separate write cycles. In frames 700 and 701, only one green common line is addressed and written at a time. The red and blue common lines are still multiplied as in FIG. 15, whereby a write waveform is applied simultaneously to multiple red common lines, and a write waveform is applied simultaneously to multiple blue common lines. Thus, in the implementation shown in FIG. 16, individual green common lines are addressed separately in both frames 700, 701, while blue and red common lines are multiplied in both frames 700, 701. Of course, in some implementations, the blue or red common lines may be independently written, while the green common lines may be multiplied. However, because the green color display elements are generally the most important for high quality visual appearance of the image, writing the green common lines independently at full resolution will generally produce a displayed image of higher quality than is the case if the green lines are multiplied with the same data and the red or blue lines are written at full resolution. The written image Data i, i+1 is displayed on display 703.

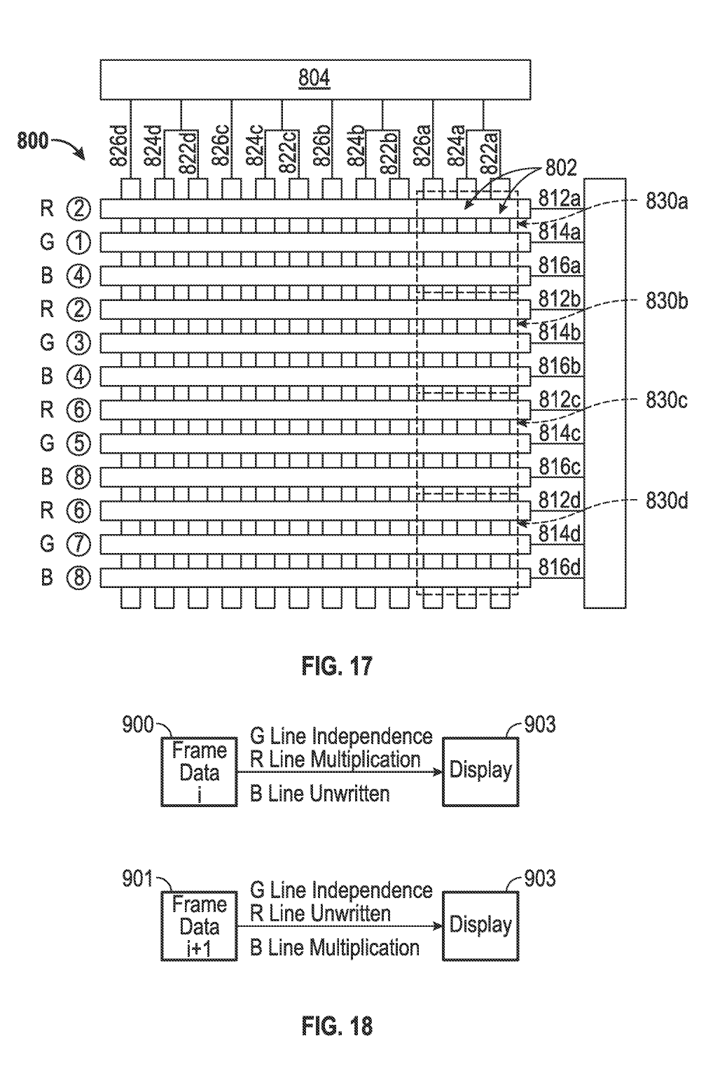

FIG. 17 shows an example of an array 800 of electromechanical display elements 802 including a plurality of common lines and a plurality of segment lines similar to that shown in FIG. 9. In some implementations, the electromechanical display elements 802 may include interferometric modulators. A plurality of segment electrodes or segment lines 822a-822d, 824a-824d, and 826a-826d, and a plurality of common electrodes or common lines 812a-812d, 814a-814d, and 816a-816d can be used to address display elements 802, as each display element 802 is in electrical communication with a segment electrode and a common electrode. Segment driver circuitry 804 is configured to apply desired voltage waveforms across each of the segment electrodes, and common driver circuitry is configured to apply desired voltage waveforms across each of the column electrodes. In certain implementations, some of the electrodes may be in electrical communication with one another, such as segment electrodes 822a and 824a, such that the same data can be simultaneously applied to each of the segment electrodes.

The array in FIG. 17 may be written according to the selective line multiplication process of FIG. 14. One such implementation is shown in FIG. 17 by reference to the ordering numerals to the left of the array. The ordering numerals illustrate one temporal order in which the common lines 812a-812d, 814a-814d, and 816a-816d may be written during a selective line multiplication process. For example, step (1) is an independent line writing process that writes only green common line 814a. Step (2) is a line multiplication process that simultaneously writes red common lines 812a and 812b. Step (3) is an independent line process that writes only green common line 814b, while step (4) is another line multiplication process that simultaneously writes blue common lines 816a and 816b. Step (5) is another independent line process that writes only green common line 814c, and step (6) is a line multiplication process that simultaneously writes red common lines 812c and 812d. Finally, step (7) is an independent line process that writes only green common line 814d, and step (8) is a line multiplication process that simultaneously writes blue common lines 816c and 816d.

The ordering of the frame writing process shown in FIG. 17 is only illustrative, however, as the ordering may be different for various applications. In yet other implementations, it may be desirable to write two or more colors simultaneously.

This selective line multiplication scheme where green lines are written at full resolution and red and blue lines are multiplied to display data at a lower resolution has particular utility for interferometric modulator displays as described above. In these displays, the green display elements function almost identically to a luminance value in a standard YUV or YC1C2 defined color space, where Y is luminance, and U and V (or C1 and C2) are chrominance values. This is an alternative image data format to the RGB format, and is more commonly used for image data manipulation and compression. Because human vision has more spatial sensitivity to luminance differences (corresponding essentially to brightness differences) than chrominance (color) differences, video systems using the YUV format can store chrominance data at lower resolution than luminance data without degrading image appearance. When the selective line doubling of FIG. 17 is used, an interferometric modulator display can map Y values of YUV data to green, and map U and V values of YUV data to red and blue. This can avoid a conversion process to RGB format that may be used when the input image data is YUV data.

The frame writing processes of FIGS. 14, 16, and 17 may reduce the overall frame write time through line multiplication of certain colors while preserving resolution by writing other colors at full resolution. The implementation of FIG. 17 may increase the frame rate of a display significantly, when compared to a full resolution frame writing process. For example, in FIG. 17, the green common lines 814a-814d are written at full resolution wherein every selected green common line 814a-814d may be written with individual display data, while the red common lines 812a-812d and the blue common lines 816a-816d are multiplied. In FIG. 17, the red and blue common lines 812a-812d, 816a-816d are doubled, as two common lines are written simultaneously. If there are N green common lines, N red common lines, and N blue common lines, then the frame writing time is proportional to N green writes+N/2 blue writes+N/2 red writes, for a total frame write time that is proportional to 2N (or a frame rate proportional to 1/2N). As shown above, this is significantly faster than the frame write time for full resolution scans (which is proportional to 3N), but it is slower than the frame write time obtained using complete line multiplication of FIGS. 9-10 (which is proportional to 1.5N). As an example, certain displays have a frame rate of approximately 15 Hz when the common lines are scanned in full resolution. In this implementation, because the write time is reduced from 3N (at 15 Hz frame rate) to 2N, the frame rate may be increased to about 23 Hz.

As with complete line multiplication, the selective line multiplication process of FIGS. 14, 16, and 17 may sacrifice some resolution at the expense of increased frame rate, because not all of the image data is used to display the information. However, the selective line multiplication implementations illustrated in FIGS. 14, 16, and 17 may improve resolution when compared to the complete line multiplication processes of FIGS. 9 and 10. In some applications, for example, a display's luminance may be dominated by the color green. In such a case, the green common lines 814a-814d may be written at full resolution, as in FIGS. 16 and 17, while the other colors (such as red and blue) are written using line multiplication. By writing green common lines 814a-814d at full resolution, the image may appear sharper or clearer to the human eye than in frame writing processes that multiplies the common lines of every color. Moreover, more raw image information is written in selective line multiplication than with complete line multiplication, which recovers some of the resolution lost by multiplying every common line.

Turning to FIG. 18, yet another implementation of the selective line multiplication process from FIG. 14 is shown. As in FIGS. 15 and 16, frames 900 and 901 include image data i, i+1, which represents the image data received by the display driver for each frame 900, 901. Like the implementations of FIG. 16, the common lines associated with one color are written independently for both frames 900, 901. For example, in FIG. 18, each selected green common line is written individually in separate write cycles from all the other common lines, in both frames 900, 901. And, like in FIG. 16, two or more common lines of one color are multiplied in frame 900, written in combined simultaneous write cycles. For instance, multiple red common lines are written simultaneously in frame 900, meaning that a write waveform is simultaneously applied to two or more red common lines in frame 900. Unlike FIG. 16, however, the common lines for another color remain unwritten during the frame 900. In FIG. 18, for instance, the blue common lines remain unwritten in frame 900. That is, no write waveform is applied to any of the blue common lines during frame 900. Rather, the blue image data i−1 from the previous frame is retained on the blue common lines. The image data i for the blue common lines therefore may remain unused in frame 900. The written image data (and the retained image data on the blue common lines) is then displayed on display 903.

After writing and displaying image data on display 903, the display driver writes selected image data i+1 for the subsequent frame 901. In frame 901, one color, in this case green, is again written independently, such that the green common lines are written at full resolution. However, unlike frame 900, the red common lines remain unwritten, while the blue common lines are multiplied, i.e., a write waveform is simultaneously applied to two or more blue common lines in frame 901. Since the red image data i+1 was not written in frame 901, the red image data i from the previous frame is retained on the red common lines. The image data i+1 for the red common lines may remain unused in frame 901. The written image data (and the retained image data on the red common lines) is then displayed on display 903.

In some implementations, the image data for the line multiplied color in a particular frame is averaged with the image data for that color in the subsequent frame. For instance, in frame 900, the displayed red image data may be derived by averaging the red image data in frame i with the red image data in frame i+1 (in which the red lines are not written). Thus, even though new red image data i+1 remains unwritten in frame 901, the displayed red image data may be an average of the red image data i with red image data i+1, resulting in a more accurate overall display appearance as the frames are sequentially written.

While FIG. 18 illustrates one particular implementation of a selective line multiplication process, it should be appreciated that there may be colors other than red, green, and blue in a particular application, and the particular order of writing and not writing the image data may vary according to the desired design. For instance, in some designs, green common lines may be multiplied, and blue or red common lines may be independently written in any desired order. Moreover, in some applications, green common lines may remain unwritten, and some colors may remain unwritten for more than one consecutive frame in order to further enhance frame rate.

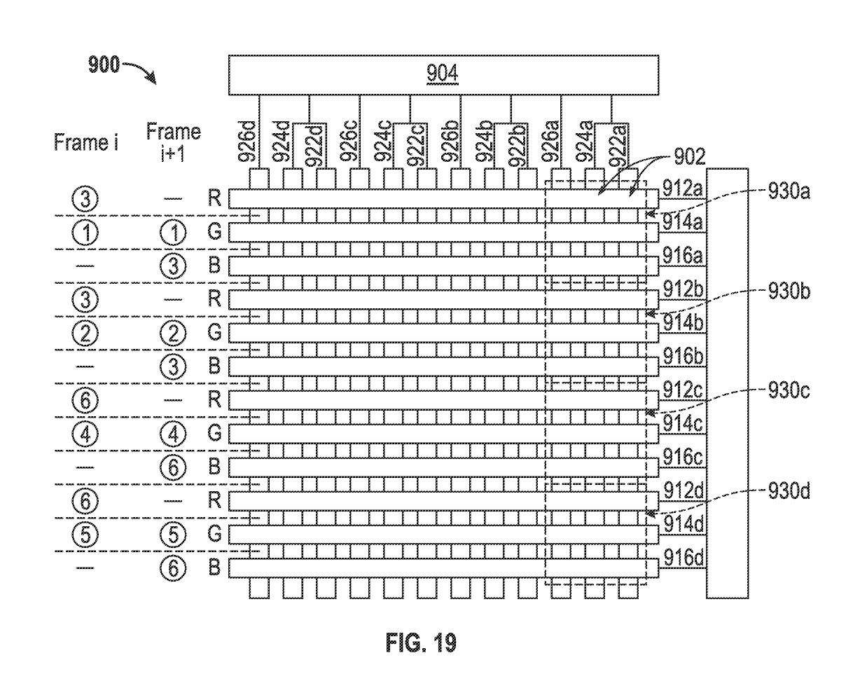

FIG. 19 illustrates an example of an array 900 of electromechanical display elements 902 including a plurality of common lines and a plurality of segment lines. In some implementations, the electromechanical display elements 902 may include interferometric modulators. A plurality of segment electrodes or segment lines 922a-922d, 924a-924d, and 926a-926d, and a plurality of common electrodes or common lines 912a-912d, 914a-914d, and 916a-916d can be used to address display elements 902, as each display element 902 is in electrical communication with a segment electrode and a common electrode. Segment driver circuitry 904 is configured to apply desired voltage waveforms across each of the segment electrodes, and common driver circuitry is configured to apply desired voltage waveforms across each of the column electrodes. In certain implementations, some of the electrodes may be in electrical communication with one another, such as segment electrodes 922a and 924a, such that the same data can be simultaneously applied to each of the segment electrodes.

The array in FIG. 19 may be written according to the selective line multiplication process of FIGS. 14 and 18. One such implementation is shown in FIG. 19 by reference to the ordering numerals to the left of the array. The ordering numerals illustrate one temporal order in which the common lines 912a-912d, 914a-914d, and 916a-916d may be written during a selective line multiplication process. As shown in FIG. 19, the lines that are written are different for consecutive frames i and i+1. In frame i, Step (1) is an independent line process that writes only green common line 914a. Step (2) of frame i is also an independent line process that writes only green common line 914b. Step (3) of frame i is a line multiplication process that simultaneously writes red common lines 912a and 912b. Steps (4) and (5) of frame i are independent line processes that separately write only green common lines 914c and 914d, respectively, in separate write cycles. Finally, Step (6) is a line multiplication process 557 that simultaneously writes red common lines 912c and 912d in a combined simultaneous write cycle.

In frame i+1, Steps (1) and (2) are the same as for frame i, whereby independent line processes are used to write only green common lines 914a and 914b, respectively, in separate write cycles. Step (3) of frame i+1 is a line multiplication process that simultaneously writes blue common lines 916a and 916b in a combined simultaneous write cycle. In Steps (4) and (5) of frame i+1, like for frame i, are independent line processes that are used to write only green common lines 914c and 914d, respectively, in separate write cycles. Finally, Step (6) is a line multiplication process that simultaneously writes blue common lines 912c and 912d in a combined simultaneous write cycle.

The implementations of FIGS. 18 and 19 may achieve a frame rate identical or similar to that of a complete common line multiplication process (such as in FIG. 15), while achieving improved resolution for the green display elements. For arrays with N green common lines, N red common lines, and N blue common lines, the frame writing time is proportional to (N green line writes)+(N/2 blue or red line writes) for a particular frame, for a total write time proportional to 1.5N (or frame rate proportional to 1/1.5N). The writing process of FIGS. 18 and 19 may therefore decrease total write time proportionally from 3N to 1.5N (or double the frame rate) because only one color (red or blue) is multiplied in a frame while the other color is not written. As an example, certain displays may have a frame rate of about 15 Hz when writing common lines at full resolution. In this implementation, therefore, the frame rate may be doubled to about 30 Hz.

In this implementation, some image accuracy is lost because some of the color data for a particular frame is unused during that frame. However, for an application where a display's luminance is dominated by green subpixels, resolution still may be improved relative to complete line multiplication because the green common lines are written at full resolution. Moreover, as described above, averaging, interpolation, or extrapolation techniques may be used to reduce the lost color information for a particular frame.

In yet another implementation, playback of the frames may result in some color breakup at the edges of moving objects due to the lost image data. To mitigate this potential problem, half the red common lines and half the blue common lines may be multiplied in a particular frame using the image data for frame i, and the other half may then be multiplied in a subsequent frame. For instance, in the array illustrated in FIG. 19, red common lines 912a and 912c may be simultaneously written in frame i, and blue common lines 916a and 916c may be simultaneously written in frame i as well. Red common lines 912b and 912d, in addition to blue common lines 916b and 916d, may remain unwritten in frame i. In this implementation, the green common lines 914a-914d may still be written at full resolution using the independent line process.

During frame i+1, the green common lines 914a-914d are written at full resolution again using an independent frame writing process. Moreover, the other half of the red and blue common lines may be written using the data for frame i+1. For instance, the red common lines 912b and 912d may be written simultaneously in frame i+1, and the remaining blue common lines 916b and 916d may also be written simultaneously in frame i+1. In frame i+1, the common lines that were written in frame i (common lines 912a, 912c, 916a, and 916c) may remain unwritten in frame i+1. This particular implementation may improve color breakup by utilizing half the color image data for the particular frame, i.e., by using half of the red and half of the blue image data i during frame i, and using the other half of the red and blue image data i+1 during frame i+1. The image may therefore be sharper at boundaries because the written image data uses updated data for both red and blue, as opposed to updated data for only one of these two colors. Of course, as noted above, there may be additional or fewer colors in the array, and green common lines may also be multiplied, while either blue or red common lines may be written independently.

In some implementations, one or two colors may be dominant in a particular image, or the image may be a black and white image. In those implementations, it may be desirable to offset the line multiplication in order to improve resolution. For example, in FIG. 19, red common lines 912a and 912b may be written simultaneously, and red common lines 912c and 912d may be written simultaneously. However, in this implementation, blue common lines 916a and 916d may be written independently, while blue common lines 916b and 916c may be written simultaneously. This can help improve the apparent resolution of the display because the two colors that are line doubled are line doubled out of phase with each other.

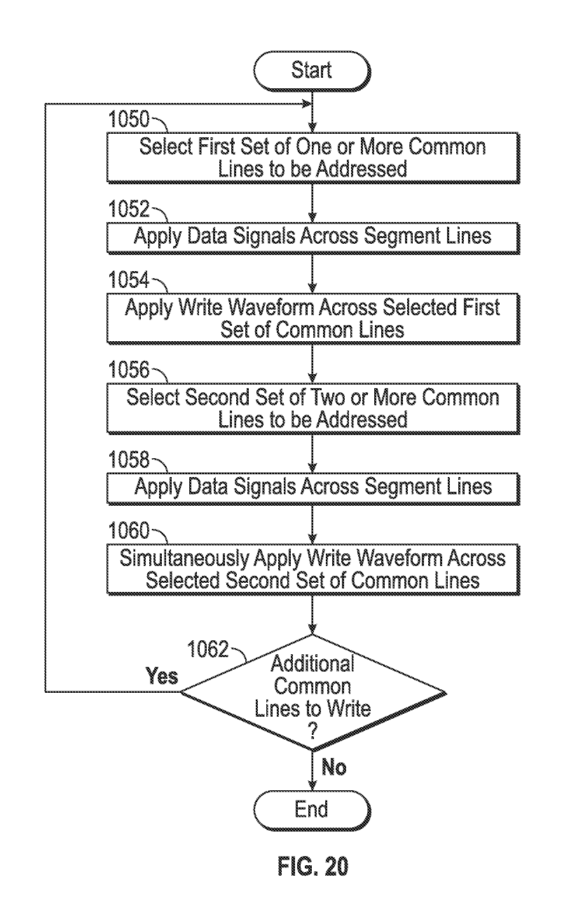

FIG. 20 shows an example of a flow diagram illustrating a process for writing data to a display using a selective common line multiplication process for two sets of common lines, according to another implementation. In FIGS. 14-19, independent common lines, such as green common lines in various implementations, are written one at a time. By writing green common lines independently (e.g., individually), the rich luminance information carried by the green color signal can be used to enhance image resolution on the display. The blue common lines and the red common lines can be written simultaneously to reduce the frame write time without sacrificing additional resolution.

However, the selective line multiplication process need not write only one independent common line at a time. Indeed, the display can include a first set of one or more common lines and a second set of two or more common lines. In the implementation of FIG. 20, the second set can include more common lines than the first set. Moreover, the first set of common lines can include display elements configured to display a first color, and the second set of common lines can include display elements configured to display a second color. The first set of common line(s) can be written simultaneously, and the second set of common lines can be written simultaneously. Because the first set of common line(s) includes fewer common lines than the second set (and indeed the first set may include only a single common line), the first color, corresponding to the first set, is written at a higher resolution than the second color for a particular frame. Similarly, because the second set of common lines includes more common lines than the first set, the frame write time for the second color in a particular frame is less than the frame write time for the first color. Thus, the first set of one or more common lines can be selected to maintain adequate image resolution, while the second set of multiple common lines can be selected to minimize or reduce frame write time. It should also be appreciated that in implementations where the first set includes more than one common line, the first set can be selected to improve frame write time as well.

For example, if the first set of common lines includes green display element(s) and if the second set includes red or blue display elements, then frame write time can be reduced by simultaneously writing the multiple red or blue common lines (and also by simultaneously writing multiple green common lines when the first set includes more than one green common line). Because there are fewer common lines in the first set (e.g., green) than there are in the second set (e.g., red or blue), adequate resolution can be maintained by writing the green common lines at a higher resolution than the blue or red common lines.

In the selective line multiplication method of FIG. 20, the method can begin at Block 1050 to select a first set of one or more common lines to be addressed. If only one common line is addressed, for example, then the selective line multiplication method of FIG. 20 is the same as the selective line multiplication method of FIG. 14. In other implementations, the first set of one or more common lines can include two, three, four, or any other suitable number of common lines. The common line(s) in the first set can be any suitable color, such as red, green, or blue. However, in one implementation, the common line(s) in the first set are green common lines, which can be advantageous in maintaining image resolution in each frame. Data signals can be applied across the segment lines in Block 1052, and a write waveform can be simultaneously applied across the selected first set of one or more common line(s) in Block 1054.

The method of FIG. 20 then moves to Block 1056 to select a second set of two or more common lines to be addressed. Any suitable number of common lines can be addressed. In one implementation, the second set of common lines includes two common lines. In other implementations, the second set of two or more common lines can include 3, 4, 5, 6, 7, 8, or any other suitable number of common lines. Moreover, the common lines in the second set can include any suitable color, including, e.g., red, green, or blue. However, in various implementations, the common lines in the second set are red or blue common lines, which can be advantageous in reducing the write time for a frame with less impact on visual appearance. Data signals can be applied across the segment lines in Block 1058, and a write waveform can be simultaneously applied across the selected second set of common lines in Block 1060. The method of FIG. 20 then moves to decision Block 1062 to determine whether additional sets of common lines are to be written. If additional lines are to be written, then the method continues at Block 1050. If no other lines are to be written, then the method ends.

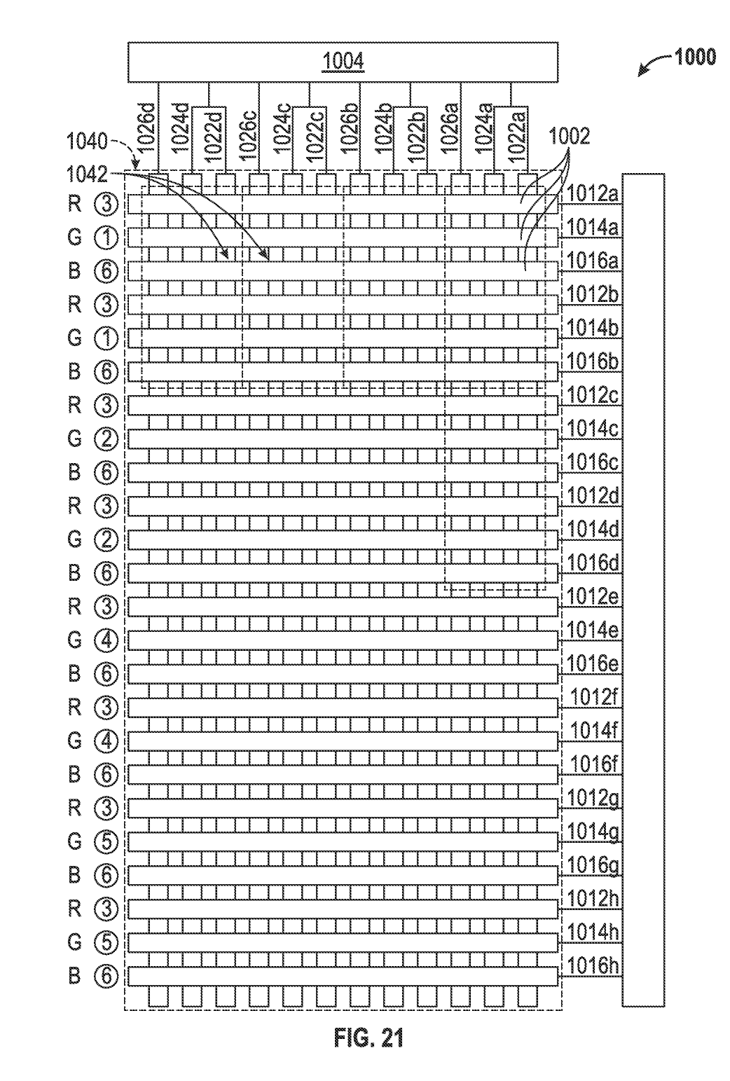

Turning to FIG. 21, yet another implementation is disclosed. FIG. 21 shows an example of an array 1000 of electromechanical display elements including a plurality of common lines and a plurality of segment lines, and includes an example common line writing scheme for a single frame, according to one implementation. As described above, it can be desirable to reduce the write time for a frame by writing multiple common lines simultaneously, while preserving as much resolution as possible. In many color displays, the green display elements are generally the most important for high quality visual appearance of the image. Indeed, as explained above, green display elements can generally correspond to a luminance value (Y) in a standard YUV or YC1C2 color space. For the disclosed implementations, for example, the green display elements may have as much as 90% correspondence to the luminance or brightness (Y). Accordingly, it may be suitable to treat the green display elements as luminance (Y) and the red and blue display elements as chrominance (Cr and Cb, respectively) for YCbCr color spaces. There may be a mismatch between Cr and red, and between Cb and blue. Although not required, such errors may be reduced by preprocessing the image data if desired. Because human vision has more spatial sensitivity to luminance differences (corresponding essentially to brightness differences) than chrominance (color) differences, video systems using the YUV or YC1C2 (or YCbCr) format can store chrominance data at lower resolution than luminance data without degrading image appearance.

As illustrated in FIG. 21, for example, a chrominance pixel 1040 can correspond to a plurality of luminance pixels 1042. For example, in FIG. 21, sixteen (16) luminance pixels 1042 correspond to or are associated with the chrominance pixel 1040, and the luminance pixels 1042 are arranged in the illustrated 4×4 configuration. In these implementations, the luminance image data is displayed with the green lines, and the chrominance image data is displayed with the red and blue lines. Because line multiplication for the green lines is less than for the red and blue lines, the luminance resolution is higher than the chrominance resolution.

FIG. 21 shows an example of an array 1000 of electromechanical display elements 1002 including a plurality of common lines and a plurality of segment lines similar to that shown in, e.g., FIGS. 9, 17, and 19. In some implementations, the electromechanical display elements 1002 may include interferometric modulators. A plurality of segment electrodes or segment lines 1022a-1022d, 1024a-1024d, and 1026a-1026d, and a plurality of common electrodes or common lines 1012a-1012h, 1014a-1014h, and 1016a-1016h can be used to address display elements 1002, as each display element 1002 is in electrical communication with a segment electrode and a common electrode. Segment driver circuitry 1004 is configured to apply desired voltage waveforms across each of the segment electrodes, and common driver circuitry is configured to apply desired voltage waveforms across each of the common electrodes. In certain implementations, some of the electrodes may be in electrical communication with one another, such as segment electrodes 1022a and 1024a, such that the same data can be simultaneously applied to each of the segment electrodes.

The portion of the display shown in FIG. 21 can be written according to the method described with respect to FIG. 20. In the implementation of FIG. 21, the first set of one or more common lines can include two green common lines, and the second set of two or more common lines can include eight red or blue common lines. For example, two green common lines can be written simultaneously, while eight red common lines can be written simultaneously and eight blue common lines can be written simultaneously. One such implementation is shown in FIG. 21 by reference to the ordering numerals to the left of the array. The ordering numerals illustrate one temporal order in which the common lines 1012a-1012h, 1014a-1014h, and 1016a-1016h may be written during a selective line multiplication process. For example, step (1) is a line multiplication process that writes only the two green common line 1014a and 1014b. Step (2) is a line multiplication process that writes only the two green common lines 1014c and 1014d. Step (3) is a line multiplication process that simultaneously writes the eight red common lines 1012a, 1012b, 1012c, 1012d, 1012e, 1012f, 1012g, and 1012h. Step (4) is a line multiplication process that writes only the two green common lines 1014e and 1014f, while step (5) is a line multiplication process that writes only the two green common lines 1014g and 1014h. Step (6) is a line multiplication process that simultaneously writes the eight blue common lines 1016a, 1016b, 1016c, 1016d, 1016e, 1016f, 1016g, and 1016h. Of course, although a particular write order is illustrated in FIG. 21, it should be appreciated that the common lines can be written in any suitable order. The write order described in FIG. 21 is for illustrative purposes only.

The frame writing processes of FIG. 21 may reduce the overall frame write time through line multiplication of certain colors while preserving visual appearance quality by writing other colors at a higher resolution. The implementation of FIG. 21 may increase the frame rate of a display significantly, when compared to a full resolution frame writing process. For example, in FIG. 21, two green common lines (e.g., lines 1014a and 1014b) are written simultaneously, eight red common lines (e.g., lines 1012a-1012h) are written simultaneously, and eight blue common lines (e.g., lines 1016a-1016h) are written simultaneously. If there are N green common lines, N red common lines, and N blue common lines, then the frame write time for a full resolution scan (e.g., independently and separately writing every common line) is proportional to 3N. In the implementation of FIG. 21, the frame writing time is proportional to N/2 green writes+N/8 blue writes+N/8 red writes, for a total frame write time that is proportional to 3N/4. Thus, the implementation of FIG. 21 can reduce the frame write time by a factor of 4. As an example, certain displays have a frame rate of approximately 15 Hz when the common lines are scanned in full resolution. In this implementation, because the write time is reduced from 3N (at 15 Hz frame rate) to 3N/4, the frame rate may be increased to about 60 Hz. Moreover, the green common lines are written at a higher resolution than the blue or red common lines. Because a display's luminance may be dominated by the color green, the image may appear sharper or clearer to the human eye than in frame writing processes that write other colors at a higher resolution, for example, by writing four lines at a time for all colors.

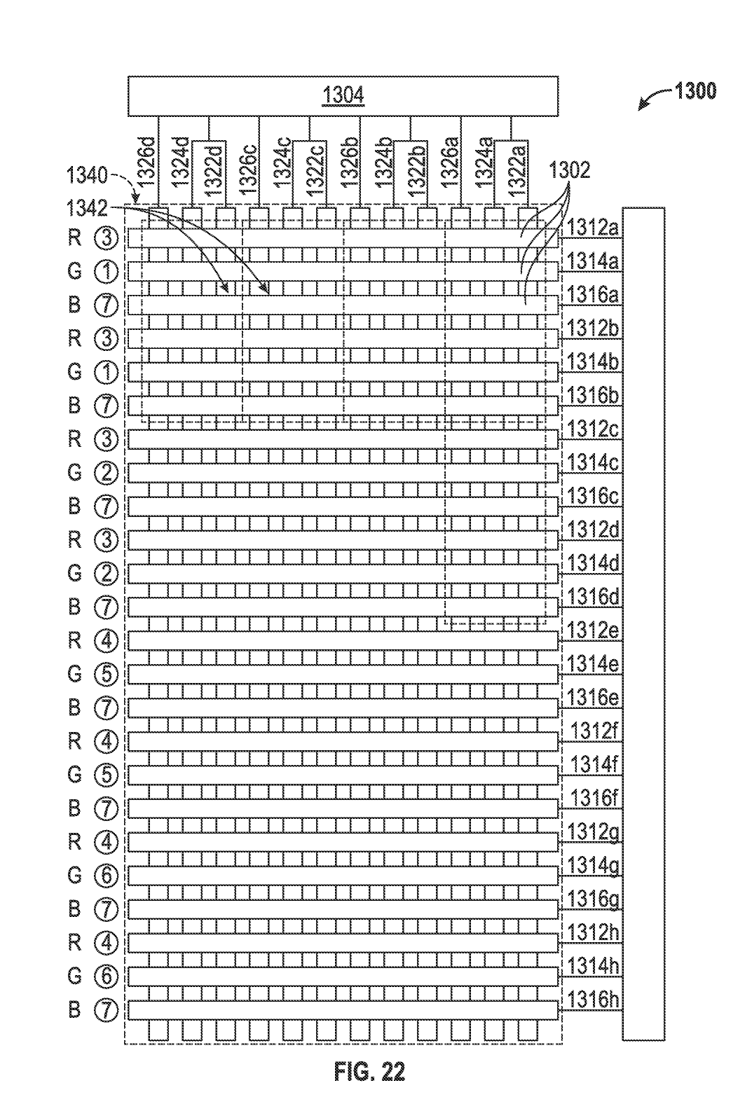

Turning to FIG. 22, another implementation is disclosed. In the implementation of FIG. 22, for example, the frame rate may be increased while reducing the overall image quality by only a small amount. As explained herein, the human eye may be more sensitive to some colors than to others. For example, the human eye is most sensitive to green, while the eye's sensitivity to red is about half its sensitivity to green. The eye's sensitivity to blue is about half its sensitivity to red. Because the eye is more sensitive to green than red and more sensitive to red than blue, various implementations disclosed herein may write the green data at a high resolution, the red data at an intermediate resolution, and the blue data at a lower resolution than the red data. Such an implementation may improve the frame rate while still maintaining high image quality.

The components in FIG. 22 may be generally similar to those described above with respect to FIG. 21, unless noted otherwise. For example, as with FIG. 21, an array 1300 of display elements is shown. A plurality of segment electrodes or segment lines 1322a-1322d, 1324a-1324d, and 1326a-1326d, and a plurality of common electrodes or common lines 1312a-1312h, 1314a-1314h, and 1316a-1316h can be used to address display elements 1302, as each display element 1302 is in electrical communication with a segment electrode and a common electrode.

The portion of the display shown in FIG. 22 can be written according to the method described with respect to FIG. 20. In the implementation of FIG. 22, the first set of one or more common lines can include two green common lines, and the second set of two or more common lines can include four red common lines. A third set of two or more common lines can include eight blue common lines. For example, two green common lines can be written simultaneously, while four red common lines can be written simultaneously and eight blue common lines can be written simultaneously. One such implementation is shown in FIG. 22 by reference to the ordering numerals to the left of the array. The ordering numerals illustrate one temporal order in which the common lines 1312a-1312h, 1314a-1314h, and 1316a-1316h may be written during a selective line multiplication process. For example, step (1) is a line multiplication process that writes only the two green common line 1314a and 1314b. Step (2) is a line multiplication process that writes only the two green common lines 1314c and 1314d. Step (3) is a line multiplication process that simultaneously writes the four red common lines 1312a, 1312b, 1312c, and 1312d. Step (4) is a line multiplication process that simultaneously writes the four red common lines 1312e, 1312f, 1312g, and 1312h. Step (5) is a line multiplication process that writes only the two green common lines 1314e and 1314f, while step (6) is a line multiplication process that writes only the two green common lines 1314g and 1314h. Step (7) is a line multiplication process that simultaneously writes the eight blue common lines 1316a, 1316b, 1316c, 1316d, 1316e, 1316f, 1316g, and 1316h. Of course, although a particular write order is illustrated in FIG. 22, it should be appreciated that the common lines can be written in any suitable order. The write order described in FIG. 22 is for illustrative purposes only. By writing the green and red image data at a higher resolution than the blue image data, and by writing the green image data at a higher resolution than the red image data, the implementation of FIG. 22 can accordingly improve the image quality as compared to the implementation of FIG. 21 by displaying each color to which the eye is more sensitive at a higher resolution than each color to which the eye is less sensitive.

It should be appreciated that other writing schemes and orders may be suitable. For example, rather than simultaneously writing two green common lines, four red common lines, and eight blue common lines, as in FIG. 22, a frame writing process can instead individually write a single green common line. The writing process can then simultaneously write two red common lines, and can simultaneously write four blue common lines. Skilled artisans will appreciate that other combinations are possible.

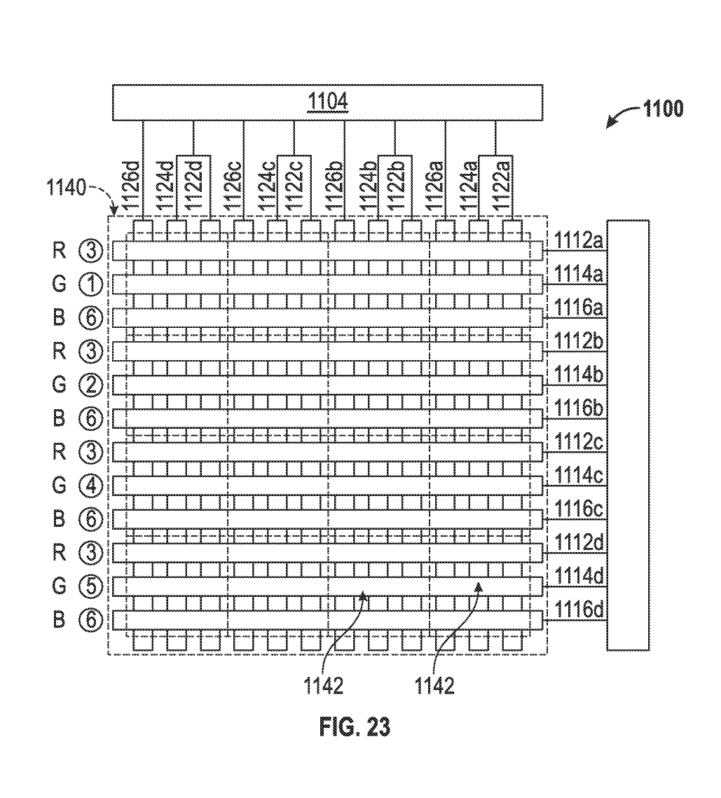

Turning to FIG. 23, another implementation is disclosed. FIG. 23 shows an example of an array 1100 of electromechanical display elements 1102 including a plurality of common lines and a plurality of segment lines similar to that shown in, e.g., FIGS. 9, 17, 19, 21, and 22. As in FIGS. 21-22, a chrominance pixel 1140 can correspond to a plurality of luminance pixels 1142. In some implementations, the electromechanical display elements 1102 may include interferometric modulators. A plurality of segment electrodes or segment lines 1122a-1122d, 1124a-1124d, and 1126a-1126d, and a plurality of common electrodes or common lines 1112a-1112d, 1114a-1114d, and 1116a-1116d can be used to address display elements 1102, as each display element 1102 is in electrical communication with a segment electrode and a common electrode. Segment driver circuitry 1104 is configured to apply desired voltage waveforms across each of the segment electrodes, and common driver circuitry is configured to apply desired voltage waveforms across each of the column electrodes. In certain implementations, some of the electrodes may be in electrical communication with one another, such as segment electrodes 1122a and 1124a, such that the same data can be simultaneously applied to each of the segment electrodes.

The portion of the display shown in FIG. 23 can also be written according to the method described with respect to FIG. 20. In the implementation of FIG. 23, the first set of one or more common lines can include one green common line, and the second set of multiple common lines can include four red or blue common lines. For example, one green common line can be written independently, while four red common lines can be written simultaneously and four blue common lines can be written simultaneously. One such implementation is shown in FIG. 23 by reference to the ordering numerals to the left of the array. The ordering numerals illustrate one temporal order in which the common lines 1112a-1112d, 1114a-1114d, and 1116a-1116d may be written during a selective line multiplication process. For example, step (1) is an independent line process that writes only the green common line 1114a. Step (2) is an independent line process that writes only the green common line 1114b. Step (3) is a line multiplication process that simultaneously writes the four red common lines 1112a, 1112b, 1112c, and 1112d. Step (4) is an independent line process that writes only the green common line 1114c, and step (5) is an independent line process that writes only the green common line 1114d. Step (6) is a line multiplication process that simultaneously writes the four blue common lines 1116a, 1116b, 1116c, and 1116d. Of course, although a particular write order is illustrated in FIG. 23, it should be appreciated that the common lines can be written in any suitable order. The write order described in FIG. 23 is for illustrative purposes only.

The frame writing processes of FIG. 23 may reduce the overall frame write time through line multiplication of certain colors while preserving resolution by writing other colors at a higher resolution. The implementation of FIG. 23 may double the frame rate of a display when compared to a full resolution frame writing process. For example, in FIG. 23, one green common line (e.g., line 1114a) is written independently, four red common lines (e.g., lines 1112a-1112d) are written simultaneously, and four blue common lines (e.g., lines 1116a-1116d) are written simultaneously. If there are N green common lines, N red common lines, and N blue common lines, then the frame write time for a full resolution scan is proportional to 3N. In the implementation of FIG. 23, the frame writing time is proportional to N green writes+N/4 blue writes+N/4 red writes, for a total frame write time that is proportional to 3N/2. Thus, the implementation of FIG. 23 can reduce the frame write time by a factor of 2. For example, consider a display with a frame rate of 15 Hz in full resolution mode. In the implementation of FIG. 23, because the write time is reduced from 3N (at 15 Hz frame rate) to 3N/2, the frame rate may be increased to about 30 Hz. As above, because green common lines are written at a higher resolution than the red or blue common lines, adequate resolution can still be maintained.

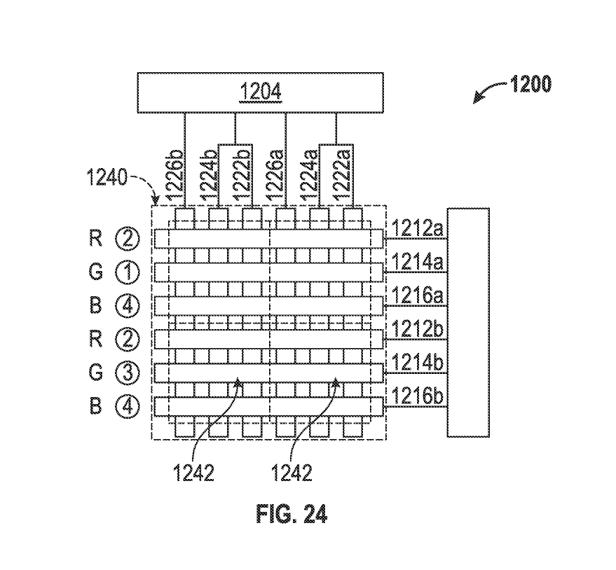

FIG. 24 shows an example of an array 1200 of electromechanical display elements including a plurality of common lines and a plurality of segment lines, and includes an example common line writing scheme for a single frame, according to yet another implementation. As above, a chrominance pixel 1240 can correspond to a plurality of luminance pixels 1242. For example, in FIG. 24, four (4) luminance pixels 1242 correspond to or are associated with the chrominance pixel 1240, and the luminance pixels 1242 are arranged in the illustrated 2×2 configuration.

The portion of the display in FIG. 24 can similarly be written according to the method described with respect to FIG. 20. Indeed, the implementation of FIGS. 20 and 24 is similar to the implementation of FIGS. 14 and 17, as shown by the ordering numerals to the left of the array. For example, the first set of one or more common lines can include a single green common line, and the second set of two or more common lines can include two red or blue common lines. As in FIG. 17, step (1) is an independent line write process that writes only the green common line 1214a. Step (2) is a line multiplication process that simultaneously writes the two red common lines 1212a and 1212b. Step (3) is an independent line write process that writes only the green common line 1214b. Step (4) is a line multiplication process that simultaneously writes the two blue common lines 1216a and 1216b. As with the implementation of FIG. 17, the implementation of FIG. 24 can reduce the frame write time to a time proportional to 2N (as compared to 3N for a full resolution scan), for displays with N red common lines, N green common lines, and N blue common lines.

Although the term “simultaneously” is used throughout the discussion of FIGS. 14-24 for the purposes of conciseness, the voltage waveforms need not be perfectly synchronized. As discussed above with respect to FIG. 5B, the write waveform may include an overdrive or address voltage during which the potential difference across a display element is sufficient to result in data being written to that display element given an appropriate segment voltage. So long as there is sufficient overlap between the overdrive or address voltages of the write waveforms applied across the common lines and the data signals applied across the segment lines that actuation of the display elements on any of the addressed common lines can occur, the write waveforms and data signals are considered to be applied simultaneously.

Although the above implementations have described the use of 3×3 pixels, it will be understood that pixels and display elements of any desired size and shape may be used in conjunction with the methods and devices discussed herein. For example, if a pixel covers more than three segment lines, or if each of the segment lines are independent of one another, an increased color or grayscale range can be provided.

The above drive schemes and other techniques need not be used in conjunction with an increase in the refresh rate of a display. For example, many of the above methods can result in significant reductions in power consumption, and may be applied in order to reduce the power utilized by a display. A reduction in power usage may be of particular interest in battery-powered or other mobile devices where a reduction in power usage can result in longer battery life.

Various combinations of the above implementations and methods discussed above are contemplated. In particular, although the above implementations are primarily directed to implementations in which interferometric modulators of particular elements are arranged along common lines, interferometric modulators of particular colors may instead be arranged along segment lines in other implementations. In particular implementations, different values for high and low segment voltages may be used for specific colors, and identical hold, release and address voltages may be applied along common lines. In further implementations, when multiple colors of subpixels are located along common lines and segment lines, such as the four-color display discussed above, different values for high and low segment voltages may be used in conjunction with different values for hold and address voltages along the common lines, so as to provide appropriate pixel voltages for each of the four colors. In addition, the methods of testing described herein may be used in combination with other methods of driving electromechanical devices.

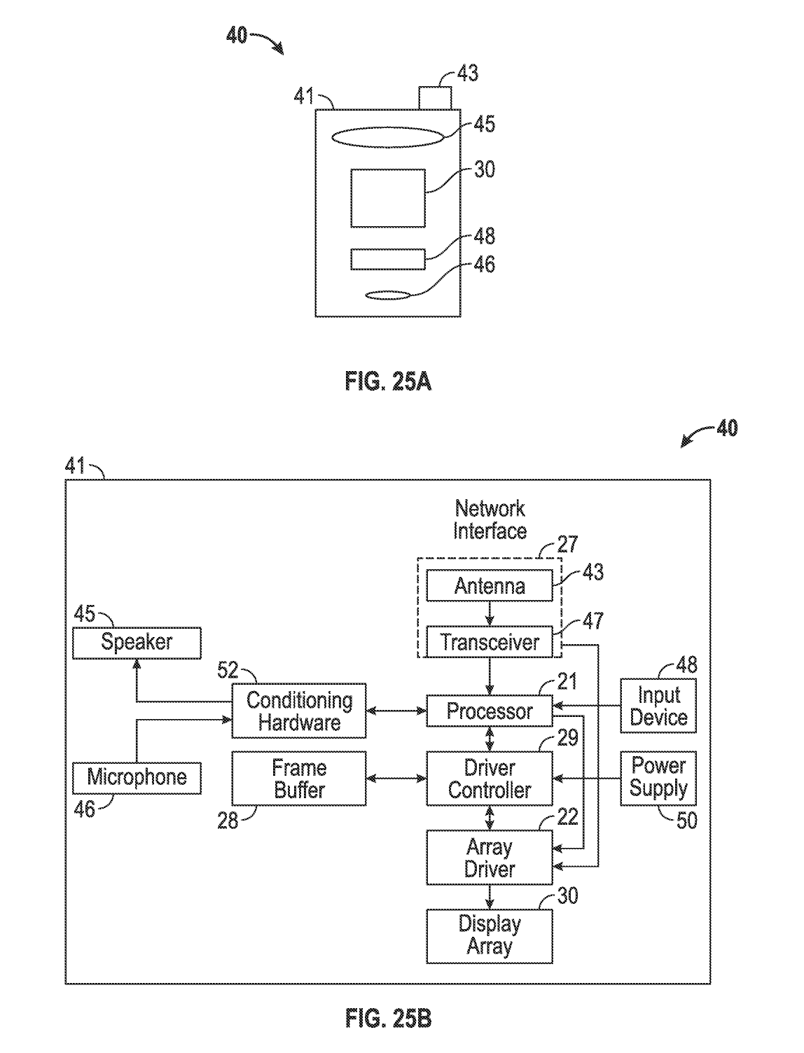

FIGS. 25A and 25B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 25B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A color display, comprising
a plurality of common lines;
a plurality of segment lines;
a plurality of electromechanical display elements, wherein each electromechanical display element is in electrical communication with one of said plurality of common lines and one of said plurality of segment lines, wherein substantially all of the electromechanical display elements along a first set of one or more common lines include electromechanical display elements configured to display a first color, and wherein substantially all of the electromechanical display elements along a second set of two or more common lines include electromechanical display elements configured to display a second color; and
driver circuitry configured to:
simultaneously apply a first plurality of data signals across a plurality of segment lines;
apply a first write waveform across only the first set of one or more common lines to selectively control the state of electromechanical display elements in electrical communication with the first set of one or more common lines;
simultaneously apply a second plurality of data signals across a plurality of segment lines; and
simultaneously apply second write waveforms across the second set of two or more common lines to selectively control the state of electromechanical display elements in electrical communication with the second set of two or more common lines,
wherein the second set of two or more common lines includes more common lines than the first set of one or more common lines.

2. The display of claim 1, wherein the first set of one or more common lines includes only one common line, and wherein the second set of common lines includes exactly two common lines.

3. The display of claim 1, wherein the first set of one or more common lines includes only one common line, and wherein the second set of common lines includes exactly four common lines.

4. The display of claim 1, wherein the first set of one or more common lines includes exactly two common lines, and wherein the second set of common lines includes exactly eight common lines.

5. The display of claim 1, wherein the second color is substantially red or substantially blue.

6. The display of claim 5, wherein the first color is substantially green.

7. The display of claim 1, wherein the driver circuitry is configured to apply said first write waveform before applying said second write waveforms.

8. The display of claim 1, wherein the driver circuitry is configured to apply said second write waveforms before applying said first write waveform.

9. The display of claim 1, wherein the electromechanical display elements include bistable display elements which exhibit hysteresis, and wherein the driver circuitry is configured to apply data signals having a variance which is less than a width of a hysteresis window of said electromechanical display elements.

10. The display of claim 1, wherein the second write waveforms are substantially identical.

11. The display of claim 1, wherein substantially all of the electromechanical display elements along a third set of one or more common lines include electromechanical display elements configured to display a third color, wherein substantially all of the electromechanical display elements along a fourth set of two or more common lines include electromechanical display elements configured to display a fourth color, and wherein the driver circuitry is further configured to, after applying said first and second write waveforms and said first and second plurality of data signals:
simultaneously apply a third plurality of data signals across a plurality of segment lines;
apply a third write waveform across only the third set of one or more common lines to selectively control the state of electromechanical display elements in electrical communication with the third set of one or more common lines;
simultaneously apply a fourth plurality of data signals across a plurality of segment lines; and
simultaneously apply fourth write waveforms across the fourth set of two or more common lines to selectively control the state of electromechanical display elements in electrical communication with the fourth set of two or more common lines,
wherein the fourth set of two or more common lines includes more common lines than the third set of one or more common lines.

12. The display of claim 11, wherein said fourth color is substantially red or substantially blue.

13. The display of claim 11, wherein said third color is substantially the same as said first color.

14. The display of claim 13, wherein said first color is substantially green.

15. The display of claim 11, wherein the driver circuitry is configured to apply said third write waveform before applying said fourth write waveforms.

16. The display of claim 11, wherein the driver circuitry is configured to apply said fourth write waveforms before applying said third write waveform.

17. The display of claim 1, wherein the display comprises a plurality of pixels, each pixel including a plurality of electromechanical display elements, wherein each pixel extends across a plurality of common lines and a plurality of segment lines.

18. The display of claim 17, wherein the driver circuitry is configured to apply a particular write waveform across each of the common lines extending through a first pixel, wherein the write waveform applied to a particular common line extending through the first pixel is simultaneously applied to a common line extending through a second pixel.

19. The display of claim 1, wherein substantially all of the electromechanical display elements along a third set of two or more common lines include electromechanical display elements configured to display a third color, and wherein the driver circuitry is further configured to:
simultaneously apply a third plurality of data signals across a plurality of segment lines;
apply a third write waveform across only the third set of two or more common lines to selectively control the state of electromechanical display elements in electrical communication with the third set of two or more common lines;
wherein the third set of two or more common lines includes more common lines than the second set of two or more common lines.

20. The display of claim 19, wherein the first color is substantially green, the second color is substantially red, and the third color is substantially blue.

21. The display of claim 1, further comprising:
a processor that is configured to communicate with the display, the processor being configured to process image data; and
a memory device that is configured to communicate with the processor.

22. The display of claim 21, further comprising a controller configured to send at least a portion of the image data to the driver circuitry.

23. The display of claim 21, further comprising an image source module configured to send the image data to the processor.

24. The display of claim 21, wherein the image source module includes at least one of a receiver, transceiver, and transmitter.

25. The display of claim 21, further comprising an input device configured to receive input data and to communicate the input data to the processor.

26. A method of driving a color display, the color display comprising a plurality of electromechanical display elements, each electromechanical display element in electrical communication with one of a plurality of segment lines and one of a plurality of common lines, the method comprising:
simultaneously applying a first plurality of data signals across a plurality of segment lines;
applying a first write waveform across only a first set of one or more common lines to selectively control the state of electromechanical display elements in electrical communication with said first set of one or more common lines, wherein substantially all of the electromechanical display elements along said first set of one or more common lines include electromechanical display elements configured to display a first color;
simultaneously applying a second plurality of data signals across a plurality of segment lines; and
simultaneously applying second write waveforms across at least a second set of two or more common lines to selectively control the state of electromechanical display elements in electrical communication with said second set of two or more common lines, wherein substantially all of the electromechanical display elements along said second set of two or more common lines include electromechanical display elements configured to display a second color,
wherein the second set of two or more common lines includes more common lines than the first set of one or more common lines.

27. The method of claim 26, wherein the first set of one or more common lines includes only one common line, and wherein the second set of two or more common lines includes exactly two common lines.

28. The method of claim 26, wherein the first set of one or more common lines includes only one common line, and wherein the second set of two or more common lines includes exactly four common lines.

29. The method of claim 26, wherein the first set of one or more common lines includes exactly two common lines, and wherein the second set of two or more common lines includes exactly eight common lines

30. The method of claim 26, wherein the electromechanical display elements include bistable display elements which exhibit hysteresis, and wherein the variance in the data signals is less than a width of a hysteresis window of said electromechanical display elements.

31. The method of claim 26, wherein the method further comprises:
after applying said first and second write waveforms and said first and second plurality of data signals, simultaneously applying a third plurality of data signals across a plurality of segment lines;
applying a third write waveform across only a third set of one or more common lines to selectively control the state of electromechanical display elements in electrical communication with said third set of one or more common lines;
simultaneously applying a fourth plurality of data signals across a plurality of segment lines; and
simultaneously applying fourth write waveforms across at least a fourth set of two or more common lines to selectively control the state of electromechanical display elements in electrical communication with said fourth set of two or more multiple common lines,
wherein the fourth set of two or more common lines includes more common lines than the third set of one or more common lines.

32. The method of claim 31, wherein substantially all of the electromechanical display elements along said third set of one or more common lines include electromechanical display elements configured to display a third color, and wherein substantially all of the electromechanical display elements along said fourth set of two or more common lines include electromechanical display elements configured to display a fourth color.

33. The method of claim 32, wherein the first and third colors are substantially green.

34. The method of claim 33, wherein the second and fourth colors are substantially red or substantially blue.

35. The method of claim 26, wherein the color display comprises a plurality of pixels, each pixel including a plurality of electromechanical display elements, wherein each pixel extends across a plurality of common lines and a plurality of segment lines, and wherein a first common line of the first set of one or more common lines extends through a first pixel, and wherein a second common line of the second set of two or more common lines extends through a second pixel, wherein said first pixel is adjacent to said second pixel.

36. The method of claim 26, comprising:
simultaneously applying a third plurality of data signals across a plurality of segment lines;
applying a third write waveform across only a third set of two or more common lines to selectively control the state of electromechanical display elements in electrical communication with the third set of two or more common lines, wherein substantially all of the electromechanical display elements along said third set of two or more common lines include electromechanical display elements configured to display a third color;
wherein the third set of two or more common lines includes more common lines than the second set of two or more common lines.

37. The method of claim 36, wherein the first color is substantially green, the second color is substantially red, and the third color is substantially blue.

38. A computer-readable storage medium comprising instructions which, when executed by one or more processors, cause a computer to perform a method of driving a color display, the color display comprising a plurality of electromechanical display elements, each electromechanical display element in electrical communication with one of a plurality of segment lines and one of a plurality of common lines, the method comprising:
simultaneously applying a first plurality of data signals across a plurality of segment lines;
applying a first write waveform across only a first set of one or more common lines to selectively control the state of electromechanical display elements in electrical communication with said first set of one or more common lines, wherein substantially all of the electromechanical display elements along said first set of one or more common lines include electromechanical display elements configured to display a first color;
simultaneously applying a second plurality of data signals across a plurality of segment lines; and
simultaneously applying second write waveforms across at least a second set of two or more common lines to selectively control the state of electromechanical display elements in electrical communication with said second set of two or more common lines, wherein substantially all of the electromechanical display elements along said second set of two or more common lines include electromechanical display elements configured to display a second color,
wherein the second set of two or more common lines includes more common lines than the first set of one or more common lines.

39. The computer-readable storage medium of claim 38, wherein the instructions cause a computer to perform a method of driving a color display further comprising:
after applying said first and second write waveforms and said first and second plurality of data signals, simultaneously applying a third plurality of data signals across a plurality of segment lines;
applying a third write waveform across only a third set of one or more common lines to selectively control the state of electromechanical display elements in electrical communication with said third set of one or more common lines;
simultaneously applying a fourth plurality of data signals across a plurality of segment lines; and
simultaneously applying fourth write waveforms across at least a fourth set of two or more common lines to selectively control the state of electromechanical display elements in electrical communication with said fourth set of two or more common lines,
wherein the fourth set of two or more common lines includes more common lines than the third set of one or more common lines.

40. The computer-readable storage medium of claim 39, wherein substantially all of the electromechanical display elements along said third set of one or more common lines include electromechanical display elements configured to display a third color, wherein substantially all of the electromechanical display elements along said fourth set of two or more common lines include electromechanical display elements configured to display a fourth color.

41. The computer-readable storage medium of claim 38, wherein the method comprises:
simultaneously applying a third plurality of data signals across a plurality of segment lines;
applying a third write waveform across only a third set of two or more common lines to selectively control the state of electromechanical display elements in electrical communication with the third set of two or more common lines, wherein substantially all of the electromechanical display elements along said third set of two or more common lines include electromechanical display elements configured to display a third color;
wherein the third set of two or more common lines includes more common lines than the second set of two or more common lines.

42. The computer-readable storage medium of claim 41, wherein the first color is substantially green, the second color is substantially red, and the third color is substantially blue.

43. A display comprising:
a plurality of electromechanical display elements, each electromechanical display element in electrical communication with one of a plurality of segment lines and one of a plurality of common lines;
means for simultaneously applying a first plurality of data signals across a plurality of segment lines;
means for applying a first write waveform across a first set of one or more common lines to selectively control the state of electromechanical display elements in electrical communication with said first set of one or more common lines, wherein substantially all of the electromechanical display elements along said first set of one or more common lines include electromechanical display elements configured to display a first color;
means for simultaneously applying a second plurality of data signals across a plurality of segment lines; and
means for simultaneously applying second write waveforms across at least a second set of two or more common lines to selectively control the state of electromechanical display elements in electrical communication with said second set of two or more common lines, wherein substantially all of the electromechanical display elements along said second set of two or more common lines include electromechanical display elements configured to display a second color,
wherein the second set of two or more common lines includes more common lines than the first set of one or more common lines.

44. The display of claim 43, further comprising:
means for simultaneously applying a third plurality of data signals across a plurality of segment lines after applying said first and second write waveforms and said first and second plurality of data signals;
means for applying a third write waveform across a third set of one or more common lines to selectively control the state of electromechanical display elements in electrical communication with said third set of one or more common lines, wherein substantially all of the electromechanical display elements along said third set of one or more common lines include electromechanical display elements configured to display a third color;
means for simultaneously applying a fourth plurality of data signals across a plurality of segment lines; and
means for simultaneously applying fourth write waveforms across at least a fourth set of two or more common lines to selectively control the state of electromechanical display elements in electrical communication with said fourth set of two or more common lines, wherein substantially all of the electromechanical display elements along said fourth set of two or more common lines include electromechanical display elements configured to display a fourth color,
wherein the fourth set of two or more common lines includes more common lines than the third set of one or more common lines.

45. The display of claim 44, wherein the first and third colors are substantially the same.

46. The display of claim 45, wherein the second and fourth colors are substantially red or substantially blue.

47. The display of claim 43, comprising:
means for simultaneously applying a third plurality of data signals across a plurality of segment lines;
means for applying a third write waveform across only a third set of two or more common lines to selectively control the state of electromechanical display elements in electrical communication with the third set of two or more common lines, wherein substantially all of the electromechanical display elements along said third set of two or more common lines include electromechanical display elements configured to display a third color;
wherein the third set of two or more common lines includes more common lines than the second set of two or more common lines.

48. The display of claim 47, wherein the first color is substantially green, the second color is substantially red, and the third color is substantially blue.

49. In a display having a set of red common lines, a set of green common lines, and a set of blue common lines, a method of writing a frame comprising:
writing image data using more write cycles for green common lines than for at least one of red and blue common lines.

50. The method of claim 49, the method further comprising:
writing image data in separate write cycles to substantially all of the set of green common lines;
writing image data in combined simultaneous write cycles to at least some of said set of blue common lines and/or said set of red common lines.

51. The method of claim 50, comprising writing image data in combined simultaneous write cycles to substantially all of said set of blue common lines and said set of red common lines.

52. The method of claim 50, comprising writing image data in combined simultaneous write cycles to at least some of said set of red common lines, and not writing image data to substantially all of the set of blue common lines in said frame.

53. The method of claim 50, comprising writing image data in combined simultaneous write cycles to at least some of said set of blue common lines, and not writing image data to substantially all of the set of red common lines in said frame.

54. The method of claim 50, wherein for each incoming frame, substantially all the green data is written to the display, and substantially half of the red data or substantially half of the blue data is written to the display.

55. The method of claim 54, further comprising alternating between writing substantially half of the red data and substantially half of the blue data with each incoming frame.

56. The method of claim 49, comprising writing image data using more write cycles for green common lines than for red common lines, and writing image data using more write cycles for red common lines than for blue common lines.
